SEQUENCE LISTING (40 sequences)

SEQ ID NO: 1 - protein, 214 aa, Homo sapiens
ELVMTQSPSSLSASVGDRVNIACRASQGISSALAWYQQKPGKAPRLLIYDASNLESGVPSRFSGSGSGTDFTLTISSLQPEDFAIYYCQQFNSYPLTFGGGTKVEIKRTVAAPSVFIFPPSDEQLKSGTASVVCLLNNFYPREAKVQWKVDNALQSGNSQESVTEQDSKDSTYSLSSTLTLSKADYEKHKVYACEVTHQGLSSPVTKSFNRGEC

SEQ ID NO: 2 - protein, 225 aa, Homo sapiens
QVKLLEQSGAEVKKPGASVKVSCKASGYSFTSYGLHWVRQAPGQRLEWMGWISAGTGNTKYSQKFRGRVTFTRDTSATTAYMGLSSLRPEDTAVYYCARDPYGGGKSEFDYWGQGTLVTVSSASTKGPSVFPLAPSSKSTSGGTAALGCLVKDYFPEPVTVSWNSGALTSGVHTFPAVLQSSGLYSLSSVVTVPSSSLGTQTYICNVNHKPSNTKVDKKVEPKSC

SEQ ID NO: 3 - protein, 105 aa, Homo sapiens
VAAPSVFIFPPSDEQLKSGTASVVCLLNNFYPREAKVQWKVDNALQSGNSQESVTZZDSKDSTYSLSSTLTLSKADYEKHKVYACEVTHQGLSSPVTKSFNRGEC

SEQ ID NO: 4 - protein, 121 aa, Homo sapiens
TPLTFGQGTRLEIKRTVAAPSVFIFPPSDEQLKSGTASVVBLLNNFYPREAKVQWKVDNALQSGNSQESVTEQDSKDSTYSLSSTLTLSKADYEKHKVYABEVTHQGLSSPVTKSFNRGEB

SEQ ID NO: 5 - protein, 121 aa, Homo sapiens
SPLTFGGGTKVEIKRTVAAPSVFIFPPSDEQLKSGTASVVGLLNNFYPREAKVQWKVDNALQSGNSQESVTEQDSKDSTYSLSSTLTLSKADYEKHKVYAGEVTHQGLSSPVTKSFNRGEG

SEQ ID NO: 6 - protein, 105 aa, Homo sapiens
TVAAPSVFIFPPSDEQLKSGTASVVCLLNNFYPREAKVQWVDNALQSGNSQESVTEQESKDSTYSLSSTLTLSKADYEKHKVYAGEVTHQGLSSPVTKSFNRGEC

SEQ ID NO: 7 - protein, 121 aa, Homo sapiens
WFRTFGQGTKVEIKRTVAAPSVFIFPPSDEQLKSGTASVVCLLNNFYHREAKVQWKVDNALQSGNSQESVTEQDSKDSTYSLSSTLTLSKADYEKHKVYACEVTHQGLSSPVTKSFNRGEC

SEQ ID NO: 8 - protein, 106 aa, Homo sapiens
TVAAPSVFIFPPSDEQLKSGTASVVCLLNNFYPREAKVQRKVDNALQSGNSQESVTEQESKDSTYSLSSTLTLSKADYEKHKVYACEVTHQGLSSPVTKSFNRGEC

SEQ ID NO: 9 - protein, 121 aa, Homo sapiens
FPYTFGQGTKLEIKRTVAAPSVFIFPPSDEQLKSGTASVVCLLDDFYPREAKVQWKVDNALQSGNSQESVTEQDSKDSTYSLSSTLTLSKADYEKHKVYACEVTHQGLSSPVTKSFNRGEC

SEQ ID NO: 10 - protein, 121 aa, Homo sapiens
FPFTFGPGTKVDIKRTVAAPSVFIFPPSDEQLKSGTASVVCLLNNFYPREAKVQWKVDNALQSGNSQESVTEQDSKDSTYSLSSTLTLSKADYEKHKVYACEVTHQGLSSPVTKSFNRGEC

SEQ ID NO: 11 - protein, 95 aa, Homo sapiens
YSPWTFGQGTKVEIKRTVAAPSVFIFPPSDEQLKSGTASVVCLLNNFYPREAKVQWKVDNALQSGNSQESVTEQDSKDSTYSLSSTLTLSKADYE

SEQ ID NO: 12 - protein, 131 aa, Homo sapiens
IELDIVVVPAPMRGSLGFDYWGQGTLVTVSSASTKGPSVFPLAPSSKSTSGGTAALGCLVKDYFPEPVTVSWNSGALTSGVHTFPAVLQSSGLYSLSSVVTVPSSSLGTQTYICNVNHKPSNTKVDKKVEP

SEQ ID NO: 13 - protein, 100 aa, Homo sapiens
ASTKGPSVFPLAPSSKSTSGGTAALGCLVKDYFPEPVTVSWNSGALTSGVHTFPAVLQSSGLYSLSSVVTVPSSSLGTQTYICNVNHKPSNTKVDKKVEP

SEQ ID NO: 14 - protein, 140 aa, Homo sapiens
ASTKGPSVFPLAPCSRSTSGGTAALGCLVKDYFPEPVTVSWNSGALTSGVHTFPAVLQSSGLYSLSSVVTVPSSSLGTQTYTCNVNHKPSNTKVDKRVELKTPLGDTTHTCPRCPEPKSCDTPPPCPRCPEPKSCDTPPP

SEQ ID NO: 15 - protein, 140 aa, Homo sapiens
ASFKGPSVFPLAPCSRSTPGGTAALGCLVKDYFPEPVTVSWNSGALTSGVHTFPAVLQSSGLYSLSSVVYVPSSSLGTQTYTCNVNHKPSNTKVDKRVELKTPLGDTTHTCPRCPEPKSCDTPPPCPRCPEPKSCDTPPP

SEQ ID NO: 16 - protein, 117 aa, Homo sapiens
STKGPSVFPLAPCSRSTSGGTAALGCLVKDYFPEPVTVSWNSGALTSGVHTFPAVLQSSGLYSLSSVVTVPSSSLGTQTYTCNVNHKPSNTKVDKRVELKTPLGDTTHTCPRCPEPK

SEQ ID NO: 17 - protein, 117 aa, Homo sapiens
FTKGPSVFPLAPCSRSTSGGTAALGCLVKDYFPEPVTVSWNSGALTSGVHTFPAVLQSSGLYSLSSVVTVPSSSLGTQTYTCNVNHKPSNTKVDKRVELKTPLGDTPPPCPRCPEPK

SEQ ID NO: 18 - protein, 103 aa, Homo sapiens
STKGPSVFPLAPCSRSTSESTAALGCLVKDYFPEPVTVSWNSGALTSGVHTFPAVLQSSGLYSLSSVVTVPSSNFGTQTYTCNVDHKPSNTKVDKTVERKCCV

SEQ ID NO: 19 - protein, 128 aa, Homo sapiens
IIYFDYADFIMDYWGQGTTVTVSTASTKGPSVFPLAPCSRSTSESTAALGCLVKDYFPEPVTVSWNSGALTSGVHTFPAVLQSSGLYSLSSVVTVPSSNFGTQTYTCNVDHKPSNTKVDKTVERKCCV

SEQ ID NO: 20 - protein, 103 aa, Homo sapiens
ASTKGPSVFPLAPCSRSTSESTAALGCLVKDYFPEPVTVSWNSGALTSGVHTFPAVLQSSGLYSLSSWTVPSSNFGTQTYTCNVDHKPSNTKVDKTVERKCCV

SEQ ID NO: 21 - protein, 104 aa, Homo sapiens
ASFKGPSVFPLAPCSRSTSESTAALGCLVKDYFPEPVTVSWNSGALTSGVHTFPAVLQSSGLYSLSSVVTVPSSNFGTQTYTCNVDHKPSNTKVDKTVERKCCV

SEQ ID NO: 22 - protein, 103 aa, Homo sapiens
STKGPSVFPLAPCSRSTSESTAALGCLVKDYFPEPVTVSWNSGALTSGVHTFPAVLQSSGLYSLSSVVTVPSSSLGTKTYTCNVDHKPSNTKVDKRVESKYGP

SEQ ID NO: 23 - protein, 128 aa, Homo sapiens
  MISC_FEATURE (83)..(83): Xaa is unknown
IIYFDYADFIMDYWGQGTTVTVSTASTKGPSVFPLAPCSRSTSESTAALGCLVKDYFPEPVTVSWNSGALTSGVHTFPAVLQXSGLYSLSSVVTVPSSSLGTKTYTCNVDHKPSNTKVDKRVESKYGP

SEQ ID NO: 24 - protein, 104 aa, Homo sapiens
ASFKGPSVFPLVPCSRSTSESTAALGCLVKDYFPEPVTVSWNSCALTSGVHTFPAVLQSSGLYSLSSVVTVPSSSLGTKTYTCNVDHKPSNTKVDKRVESKYGP

SEQ ID NO: 25 - protein, 105 aa, Homo sapiens
STKGPSVFPLAPSSKSTSGGTAALGCLVKDYFPEPVTVSWNSGALTSGVHTFPAVLQSSGLYSLSSVVTVPSSSLGTQTYICNVNHKPSNTKVDKRVEPKSCDKT

SEQ ID NO: 26 - protein, 120 aa, Homo sapiens
RDTAMFFAHWGQGTLVTVSSASTKGPSVFPLAPSSKSTSGGTAALGCLVKDYFPQPVTVSWNSGALTSGVHTFPAVLQSSGLYSLSSVVTVPSSSLGTQTYICNVNHKPSNTKVDKKVEP

SEQ ID NO: 27 - protein, 127 aa, Homo sapiens
GGHGFCSSASCFGPDYWGQGTPVTVSSASTKGPSVFPLAPSSKSTSGGTAALGCLVKDYFPQPVTVSWNSGALTSGVHTFPAVLQSSGLYSLSSVVTVPSSSLGTQTYICNVNHKPSNTKVDKRVEP

SEQ ID NO: 28 - protein, 118 aa, Homo sapiens
VPLVVNPWGQGTLVTVSSASTKGPSVFPLAPSSKSTSGGTAALGCLVKDYFPQPVTVSWNSGALTSGVHTFPAVLQSSGLYSLSSVVTVPSSSLGTQTYICNVNHKPSNTKVDKRVAP

SEQ ID NO: 29 - protein, 113 aa, Homo sapiens
FAYWGQGTLVTVSAAKTTPPSVYPLAPGSAAQTNSMVTLGCLVKGYFPEPVTVTWNSGSLSSGVHTFPAVLQSDLYTLSSSVTVPSSTWPSETVTCNVAHPASSTKVDKKIVP

SEQ ID NO: 30 - protein, 125 aa, Homo sapiens
VLFQQLVLYAPFDIWGQGTMVTVSSASTKGPSVFPLAPSSKSTSGGTAALGCLVKDYFPQPVTVSWNSGALTSGVHTFPAVLQSSGLYSLSSVVTVPSSSLGTQTYICNVNHKPSNTKVDKKVEP

SEQ ID NO: 31 - protein, 127 aa, Homo sapiens
RDYYDSGGYFTVAFDIWGQGTMVTVSSASTKGPSVFPLAPSSKSTSGGTAALGCLVKDYFPEPVTVSWNSGALTSGVHTFPAVLQSSGLYSLSSVVTVPSSSLGTQTYICNVNHKPSNTKVDKKVEP

SEQ ID NO: 32 - protein, 134 aa, Homo sapiens
GAGVTLVRGAIKPSPDYYYGMDVWGQGTTVTVSSASTKGPSVFPLAPSSKSTSGGTAALGCLVKDYFPEPVTVSWNSGALTSGVHTFPAVLQSSGLYSLSSVVTVPSSSLGTQTYICNVNHKPSNTKVDKRVEP

SEQ ID NO: 33 - protein, 127 aa, Homo sapiens; identical to SEQ ID NO: 27

SEQ ID NO: 34 - protein, 111 aa, Homo sapiens
GDVYNRQWGQGTLVTVSSASTKGPSVFPLAPSSKSTSGGTAALGBLVKDYFPEPVTVSWNSGALTSGVHTFPAVLQSSGLYSLSSVVTVPSSSLGTQTYIBNVNHKPSNTK

SEQ ID NO: 35 - protein, 118 aa, Homo sapiens
GDVYNRQWGQGTLVTVSSASTKGPSVFPLAPSSKSTSGGTAALGCLVKDYFPEPVTVSWNSGALTSGVHTFPAVLQSSGLYSLSSVVTVPSSSLGTQTYICNVNHKPSNTKVDKRVEP

SEQ ID NO: 36 - protein, 117 aa, Homo sapiens
DVYNRQWGQGTLVTVSSASTKGPSVFPLAPCSRSTSESTAALGCLVKDYFPEPVTVSWNSGALTSGVHTFPAVLQSSGLYSLSSVVTVPSSNFGTQTYTCNVDHKPSNTKVDKTVER

SEQ ID NO: 37 - protein, 122 aa, Homo sapiens
PYGGGKSEFDYWGQGTLVTVSSASTKGPSVFPLAPSSKSTSGGTAALGCLVKDYFPEPVTVSWNSGALTSGVHTFPAVLQSSGLYSLSSVVTVPSSSLGTQTYICNVNHKPSNTKVDKKVEP

SEQ ID NO: 38 - protein, 119 aa, Homo sapiens
LIAGGIDVWGQGSLVTVSSASTKGPSVFPLAPSSKSTSGGTAALGCLVKDYFPEPVTVSWNSGALTSGVHTFPAVLQSSGLYSLSSVVTVPSSSLGTQTYICNVNHKPSNTKVDKKVEP

SEQ ID NO: 39 - protein, 119 aa, Homo sapiens; identical to SEQ ID NO: 38

SEQ ID NO: 40 - protein, 123 aa, Homo sapiens
ETMASRKRAFDIWGQGTMVTVSAASTKGPSVFPLAPCSRSTSGGTAALGCLVKDYFPEPVTVSWNSGALTSGVHTFPAVLQSSGLYSLSSVVSVPSSNLGTQTYTCNVNHKPSNTKVDKTVEL

(19) United States
(12) Patent Application Publication
(10) Pub. No.: US 2009/0138208 A1
(43) Pub. Date: May 28, 2009

(54) IMMUNOGLOBULIN G BINDING POCKET

(75) Inventors: ANDREAS AXEN, Uppsala (SE); Herbert Baumann, Uppsala (SE); Enrique Carredano, Uppsala (SE)

Correspondence Address: GE HEALTHCARE BIO-SCIENCES CORP.;PATENT DEPARTMENT, 800 CENTENNIAL AVENUE, PISCATAWAY, NJ, 08855, US

(73) Assignee: GE HEALTHCARE BIO-SCIENCES AB, UPPSALA (SE)

(21) Appl. No.: 12/357,651

(22) Filed: Jan. 22, 2009

Related U.S. Application Data
(62) Division of application No. 10/532,369, filed on Apr. 20, 2005, now abandoned.

(30) Foreign Application Priority Data
Oct. 31, 2002 (SE) 0203226-6

(51) Int. Cl. G06F 19/00

(52) U.S. Cl. 702/19

(57) ABSTRACT

The present invention relates to a human IgG binding pocket comprised of a first interacting surface, which originates from an IgG κ light chain, and a second interacting surface, which originates from an IgG heavy chain, which amino acids are strictly conserved between human IgGs of κ-type. The invention also embraces an isolated and purified polypeptide, which comprises said binding pocket. Further, the invention relates to various methods of using the novel binding pocket, such as in screening for identification of chemical entities capable of selective binding thereof, and in other experimental and/or virtual methods for design and/or identification of chemical entities capable of selective binding thereof.

### CROSS-REFERENCE TO RELATED APPLICATIONS

This application is a divisional of U.S. patent application Ser. No. 10/532,369 filed Apr. 20, 2005, which is a filing under 35 U.S.C. § 371 and claims priority to international patent application number PCT/SE2003/001435 filed Sep. 12, 2003, published on May 13, 2004, as WO 2004/039843, which claims priority to patent application number 0203226-6 filed in Sweden on Oct. 31, 2002.

### FIELD OF THE INVENTION

The present invention relates to the field of biochemistry, and more specifically to the identification of a novel binding site, which is strictly conserved among human IgGs of κ-type. The present invention also encompasses use of the novel binding site for identification and/or design of chemical entities capable of specific binding to such antibodies.

### BACKGROUND OF THE INVENTION

The field of biochemistry began about a hundred years ago with a realisation that life processes involved phenomena that could be explained by the exact sciences of chemistry and physics. The early discoveries were mostly of general nature, but with time, the discipline of biochemistry matured and eventually became a well-accepted field as such. During the past decades, the growth within the field of biochemistry has been extensive and expansive, and numerous areas thereof are these days recognised, such as bioenergetics, molecular biology, membrane biochemistry, protein biochemistry, analytical biochemistry and many others.

A number of these areas utilise a steadily increasing number of biotechnological applications that involve antibodies, also known as immunoglobulins. As is well known, there are five different types of antibodies, namely immunoglobulin G (IgG), which is the most prevalent; immunoglobulin A (IgA); immunoglobulin M (IgM); immunoglobulin D (IgD); and immunoglobulin E (IgE). As is also well-known, antibodies can be prepared in two different forms, either as polyclonal antibodies, including various forms of antibodies, or as monoclonal antibodies, which is a form of pure antibodies produced by hybridomas. For many applications, the monoclonal antibodies are preferred. Examples of biotechnological applications of monoclonal antibodies are various immunochemical techniques, such as immunoaffinity extraction and chromatography, immunochemical detectors, immunoblotting, receptor assays, enzyme inhibition assays, displacement assays and flow-injection immunoassays. For most medical applications, such as diagnosis, prevention and cure of disease, monoclonal antibodies are also most preferred, for example as biopharmaceuticals. At present, about thirty percent of the biotechnology-derived drugs under development are based on monoclonal antibodies of type G.

The Y-shaped disposition of the structure of the IgG molecule is well known from standard biochemistry textbooks. It is also well known that regarding its tertiary structure, one intact IgG molecule consists of six globular regions, each of which is formed by two domains. All domains in an IgG molecule have in turn similar structures, a characteristic fold, which has become known as the immunoglobulin fold. The secondary structure of this fold consists mainly of two beta sheets packed against each other. On the other hand, regarding its primary structure, IgGs consists of two light chains and two heavy chains, which are covalently, linked by four disulphide bridges strategically placed around the central juncture of the intact molecule also called the hinge region. The two globular parts, which correspond to the “base of the Y”, form the Fc fragment and are formed by domains consisting of only heavy chain residues. Contrary to this, each of the “arms of the Y” constitute a Fab fragment with two globular parts each. Each of the globular parts in a Fab fragment is formed when one domain from the light chain contacts one domain from the heavy chain. It is well known that the globular part located further away from the centre of the antibody contains the so-called hypervariable regions and the antigen-binding site. The domains forming this part are known as V_{L} for the light chain domain and V_{H} for the heavy chain domain. On the other hand the globular part of the Fab fragment closer to the hinge region is formed by the so-called first constant domain of the heavy chain (CH1) and the constant domain of the light chain (CL). Correspondingly, the two globular parts forming the Fc fragment are formed one by two-second constant domains (CH2) and the other by two third constant domains of the heavy chain (CH3).

By sequence homology, heavy chains of IgGs can be classified into four types 1, 2, 3 and 4 whereas light chains fall into two types called λ and κ. It is also well known that in humans about 40% of the IgG molecules carry a light chain of λ type whereas about 60% carry a light chain of κ type. IgGs which are built up of both light and heavy chains inherit both types of partitioning. Accordingly, one partitioning divides IgGs into four subclasses IgG1, IgG2, IgG3 and IgG4 as compared to the second partitioning which divides IgGs into two subtypes λ and κ. The same type of classification can be applied to antibody fragments like Fab fragments and so called F(ab′)₂ fragments, which consist of two Fab fragments connected by a disulphide.

IgGs can be generated according to standard techniques in large quantities in cellular expression systems. The most widely used production method today includes purification via affinity chromatography based on the use of highly specific domains of proteins as affinity ligands. Illustrative examples of such IgG-binding protein ligands are protein A and protein G, which are cell wall proteins of the bacteria Staphylococcus aureus and group G Streptococcus, respectively. They both bind with different affinities to Fab and Fc fragments of various IgG types.

More specifically, protein A binds to IgG molecules from various mammals, with the highest affinity to the human subclasses of IgG1, IgG2 and IgG4. It binds primarily to a surface formed at the juncture of both the second and the third constant domains (CH2 and CH3) of IgG located on the Fc fragment, and can consequently not be used in affinity purification of other fragments of IgG such as Fab and so called F(ab′)₂ fragments. Protein A binds to some Fab fragments however this binding is not generic since it targets the variable region. This lack of generality is a drawback under some circumstances, since the use of Fab and F(ab′)₂ fragments has increased lately due to their considerably smaller size, as compared to intact IgG molecules, while still containing the functional antigen-binding region. For instance, the smaller size is an advantage in the penetration of tumours with limited vascular supply in order to deliver cytotoxic payloads such as radionuclides, toxins, and chemotherapeutic agents to target cancer cells. On the other hand, protein G binds also to both Fc and Fab. Protein G binds partly to the same Fc fragments surface as protein A, but their ways of binding have been shown to be completely different. Protein G binds also to a highly conserved region of the constant part of the Fab fragment, primarily to residues from the heavy chain, and consequently it has potential to be used as a generic Fab binder. However, it has been reported that protein G has a reduced binding to Fab fragments of type IgG2. In addition to the above, protein ligands of this kind are often relatively expensive to produce, they are amenable to proteolytic degradation and they are also usually sensitive to both high and low pH values.

Accordingly, the development of novel and alternative ligands to IgG, which do not necessarily need to be proteins or even protein-based, is motivated. Such development would gain from a more thorough understanding of the binding properties of the IgG molecule. Even though methods for identification of novel ligands can be based on an experimental identification on a random basis, such as in screening, they still require use of a selected binding site or at least area on the target molecule. Moreover an alternative and in many cases complementary approach known from drug-discovery contexts as rational design requires knowledge of the three-dimensional structure of a limited region which can serve as a binding site.

In the random or screening approach, various methods have been suggested in the art for identification of chemical entities that bind specifically to an antibody or any target molecule in general. For example, phage display has been used to identify peptides with affinity to the Fc fragment of IgG. However, phage display can only produce peptidic ligands, which suffer from the above-discussed drawbacks related to degradation. Also, there is no guarantee as to the generality of the binding since there is commonly no knowledge as to where on the target molecule used in screening the ligand actually binds.

Recently, computational tools have found a relatively widespread use in the field of understanding the binding properties of target molecules based on their known 3D structures. This is not in itself a new field. The pioneering work of B. Lee and F. M. Richards in the 1970s has inspired many investigators. However, as structural data and faster computers become available it is also less complicated to reveal the complex architecture of protein surfaces. For example, surfaces on proteins capable of interacting with binding molecules may include pockets, tunnels, channels, clefts and depressions. All these concepts may be covered by the more general term cavity the shape and accessibility of which, determines which concept is more appropriate. Accordingly, a depression is more accessible and flatter in shape than a cleft, which in turn is more accessible and flatter than a channel. Pockets and tunnels may be considered types of channels and as compared to a pocket a tunnel is more accessible since it has at least two entrances or connections to the outside of the protein. An additional type of cavity is the void. However a void is completely surrounded by protein atoms and therefore not accessible and therefore not appropriate for ligand binding.

In order to investigate affinity of antigen binding, seven different groups have performed structural studies of human or humanised antibodies of κ-type (see e.g. Chacko S, Padlan E A, Portolano S, McLachlan S M, Rapoport B. Structural Studies of human autoantibodies. J. Biol. Chem. 1996. 271: 12191-1298. However, in the ribbon drawing and stereodrawing or any other type of information disclosed, there are no suggestions of the above discussed surfaces, such as pockets, that would indicate especially useful interacting surfaces for binding purposes located on the constant region of the Fab fragment.

Further, Hoshii et al (Hoshii, Y., Setguchi, M., Iwata, T., Ueda, J., Cui, J., Kawano, H., Gondo, T., Takahashi, M., and Ishihara, T in “Useful polyclonal antibodies against synthetic peptides corresponding to immunoglobulin light chain constant region for immunohistochemical detection of immunoglobulin light chain amyloidosis”, Pathology International 2001; 51: 264-270). Antibodies were generated using synthetic peptides comprised of 17-18 amino acids. Consequently, the antigen used therein is too short to allow any three-dimensional structure, and consequently, it is highly improbable that those linear peptides would give rise to a pocket-shaped structure.

Virtual methods have for example been suggested for identifying molecules capable of binding to proteins, and usually involve the identification of a cleft in the three dimensional structure of the target. However, if stronger binding is desired, a more advantageous conformation of the binding site can e.g. be a more pocket-like conformation, which spatially encloses the binding molecule to a larger extent than a cleft thereon allowing a maximisation of the number of possible interactions at the atomic level like hydrogen bonds, van der Waals, and electrostatic interactions, and therefore of the binding strength. This is especially the case if the ligand is a small organic molecule, which can have the advantage of being generally more stable than larger entities like peptides and proteins. As compared to pockets and clefts, the depression is the less advantageous for binding a small molecule because it offers the smallest possibilities to complement the surface of the small molecule.

Thus, WO 01/37194 (Vertex Pharmaceuticals) discloses molecules and molecular complexes that comprise the active site binding pocket of the enzyme caspase-7. Methods are also disclosed, wherein the structural coordinates of caspase-7 are used to screen and design chemical entities that bind caspase-7 or homologues thereof. However finding a conserved binding pocket on the surface of an antibody is a more challenging task as compared to enzymes, which generally contain a substrate pocket related to their function. Antibodies like any other proteins that are not enzymes may or may not contain pockets or any other type of cavities. This is especially true for the constant domains of antibodies, which as compared to variable domains do not include the antigen-binding region that is often associated with a pocket.

Accordingly, despite the attempts that have been made so far, there is still a need in this field of alternative fast, easy and preferably easily applicable methods that are useful for the identification of novel IgG-binding molecules. As discussed above, since a useful starting point in the design of such novel methods is to select an advantageous binding site on the target molecule, there is also a need in this field of identifying novel binding sites within the IgG molecule. Moreover, if due to stability problems or other problems, it is required that the novel binding molecule is small, as compared to peptides and proteins that can be considered large in this context, then the novel binding site should be an accessible cavity. More specifically, in the order of decreasing preference the cavity should be a pocket, a tunnel or a cleft.

### SUMMARY OF THE INVENTION

Thus, the object of the present invention is to fulfill one or more of the above discussed needs. More specifically, one object of the present invention is to provide a tool useful e.g. for identification of novel IgG binding chemical entities and for other purposes. This can be achieved by the compound or binding pocket as defined in the appended claims.

A specific object of the invention is to provide a binding site in the constant region of the Fab part of an antibody, which binding site e.g. is suitable for use in the design of an antibody-selective medium. An even more specific object of the invention is to identify such a binding site in a region of the constant part of Fab, wherein the variability is as small as possible. Thus, yet another object is to provide a compound that can also be used for purification of any of the following: Fab fragments, F(ab′)₂ fragments and intact IgGs of κ-type, or compositions that comprise one or more of the ones mentioned.

A further object of the present invention is to provide a method for identification of IgG ligands. This can be achieved by use of the compound or binding pocket according to the invention as defined in the appended claims. A specific object of the invention is to provide a method for virtual screening of small molecule ligands that are capable of binding to IgG.

Yet another object of the invention is to provide further uses of the compound or binding pocket according to the invention.

Further objects and advantages of the present invention will appear from the detailed description of the invention and the experimental part that follows.

### DEFINITIONS

The term “binding pocket”, as used herein, refers to a region of a molecule or molecular complex, that as a result of its shape, favourably associates with another chemical entity. The term “composite binding pocket” as used herein means a three-dimensional structure that is formed as a pocket between a light chain and a heavy chain of an antibody. The term “interacting surface” means herein a surface comprised of residues capable of interacting with a binding molecule or other entity, e.g. by ionic attraction, hydrogen bonds, Van der Waals interaction etc.

The term “strictly conserved” is used herein to mean that after a sequence alignment of all sequences available from an internationally recognised sequence database (for instance the non-redundant database provided by the National Center for Biotechnology Information), the residue type is exactly the same at a specific position for all aligned sequences.

The terms “antibody of κ type”, “Fab fragment of κ type” and “F(ab′)₂ fragment of κ type” mean herein an antibody, a Fab fragment and an F(ab′)₂ fragment respectively, wherein the light chain is of κ type.

The term “functional derivative” is used to mean a chemical substance that is related structurally and functionally to another substance. Thus, a functional derivative comprises a modified structure from the other substance, and maintains the function of the other substance, which in this instance means that it maintains the ability to interact with the same ligands. Thus, a “functional derivative” can be either a natural variation or fragment thereof, or a recombinantly produced entity. In addition, a “functional derivative” can also comprise added molecules or parts, as long as the described function is essentially retained.

The term “human κ-Fab constant part-comprising composition” means herein any composition comprising the globular region of an IgG molecule formed by the first constant domain of the heavy chain (CH1) and the constant domain of the light chain (CL). Thus the term includes any of the following terms which are well known from standard IgG terminology: Intact IgG molecules, F(ab′)₂ fragments, Fab′ fragments, Fab fragments and by definition the globular region named itself, all of which have human sequences and light chains of κ-type. This definition includes also any modifications of named IgG or named antibody fragments including even chimeric molecules formed in one part of one of said compositions and in another part of any of the following proteins, peptides, carbohydrates, lipids or any other organic or inorganic entity and chimeric combinations thereof and also any of the above-mentioned covalently attached to solid phase.

The term “structure coordinates” refers to Cartesian coordinates derived from for example mathematical equations related to the patterns obtained on diffraction of a monochromatic beam of X-rays by the atoms (scattering centres) of a protein or protein-ligand complex in crystal form. The diffraction data are used to calculate an electron density map of the repeating unit of the crystal. The electron density maps are then used to establish the positions of the individual atoms of the protein or protein complex.

The term “root mean square deviation” means the square root of the arithmetic mean of the squares of the deviations from the mean. It is a way to express the deviation or variation from a trend or object.

The term “docking” means herein a fitting operation, wherein the ability of a chemical entity to bind or “dock” to a binding site is evaluated.

The term “associating with” refers to a condition of proximity between a chemical entity, or portions thereof, and a target i.e. a binding pocket or binding site on a protein. The association may be non-covalent, wherein the juxtaposition is energetically favoured by hydrogen bonding or van der Waals or electrostatic interactions, or alternatively it may be covalent.

The term “library” means a collection of molecules or other chemical entities with different chemical structures and/or properties.

The term “query” means herein the definition of the criteria or properties of desired chemical entities that must be fulfilled for said entity to qualify as a hit in docking or screening. Accordingly, a “hit” means a chemical entity that fulfills the criteria of a query.

The term “chemical entity” is used herein for any molecule, chemical compound or complex of at least two chemical compounds and fragments of such compounds or complexes.

The term “ligand” means herein a chemical entity capable of specific binding to a target. To “experimentally” contact a chemical entity with a target, or to “experimentally” provide a chemical entity, ligand or the like, means herein that it is provided physically, as opposed to virtually.

### BRIEF DESCRIPTION OF THE DRAWINGS

FIG. 1 shows the structure coordinates of a human IgG of κ-type in the order. More specifically, FIG. 1(a) shows the light chain of a human IgG of κ-type, while FIG. 1(b) shows the structure coordinates of the heavy chain of a human IgG.

FIGS. 2 (a) and (b) show the alignment of human IgG Fab constant part light and heavy chain sequences of κ-type used in the identification of the binding pocket according to the invention.

FIG. 3 shows an example of a query useful in 3D-verify mode in a docking step as used in example 2 below, wherein the residues belonging to the compound or binding pocket are shown in ball and stick.

FIG. 4 shows a stick model of eight overlaid structures of Fab fragments of kappa type from the protein data bank in the region of the pocket identified according to the present invention.

### DETAILED DESCRIPTION OF THE INVENTION

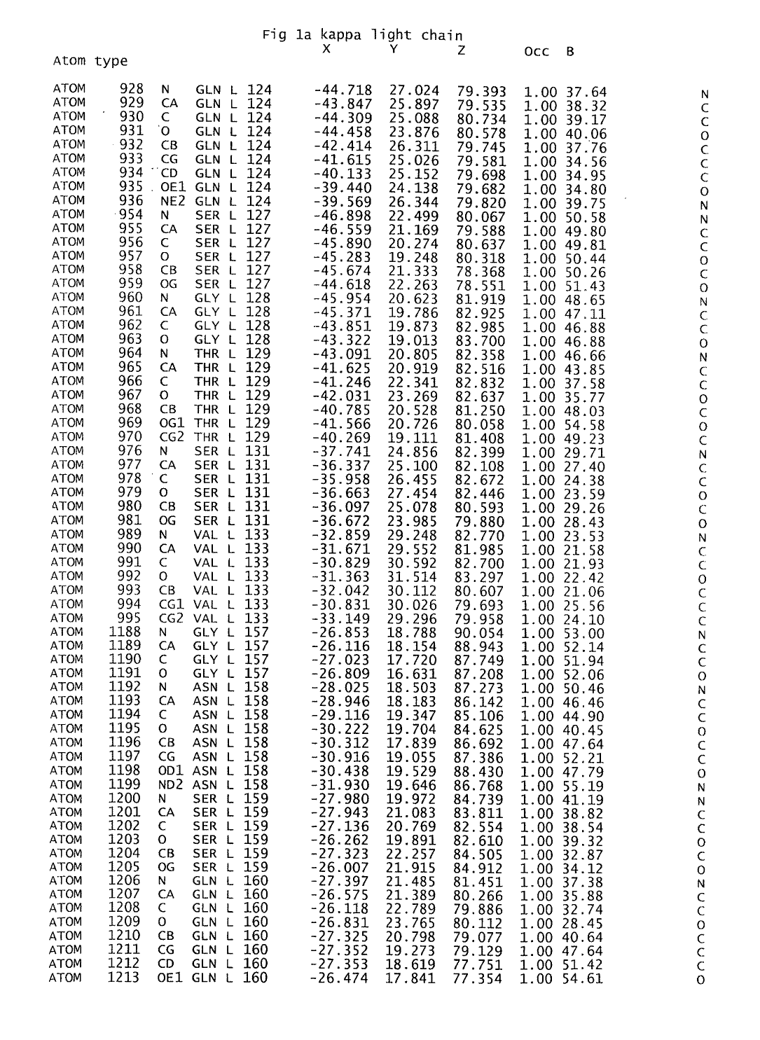

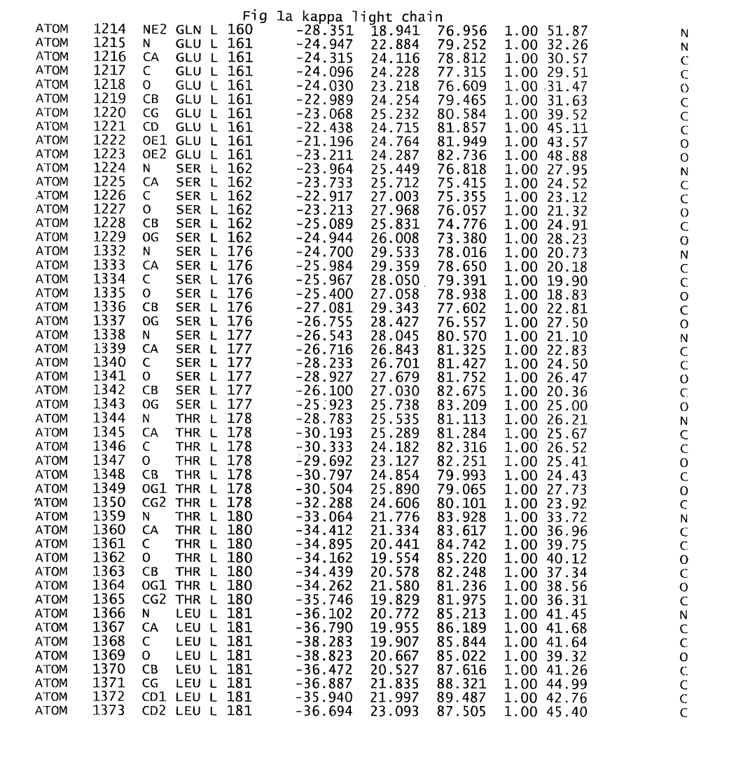

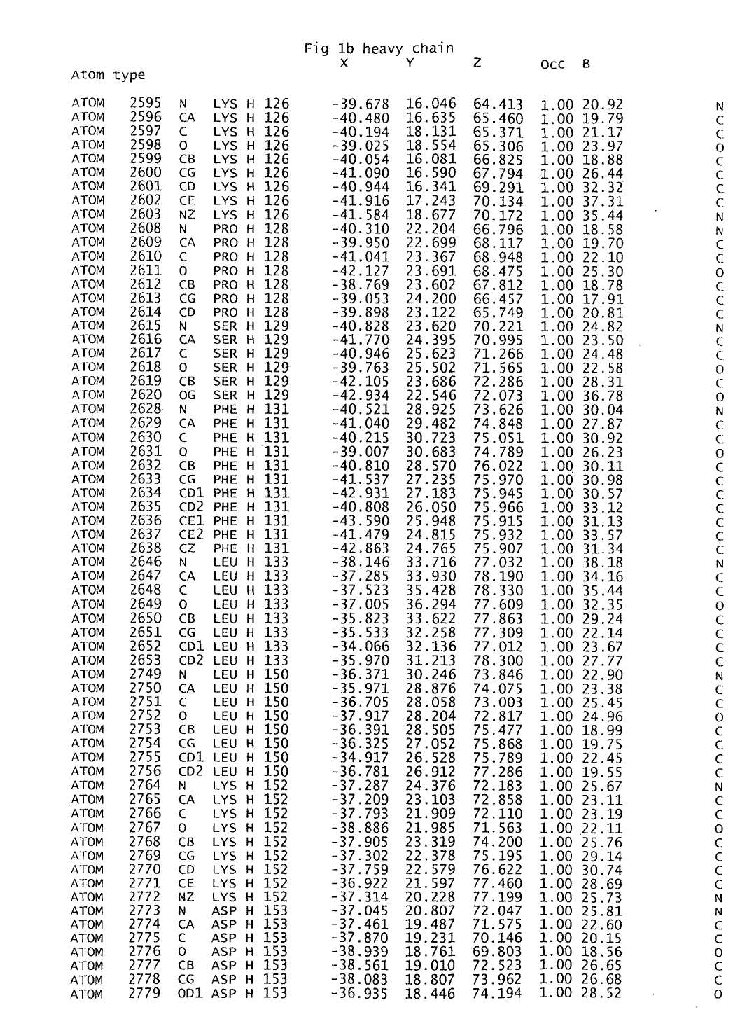

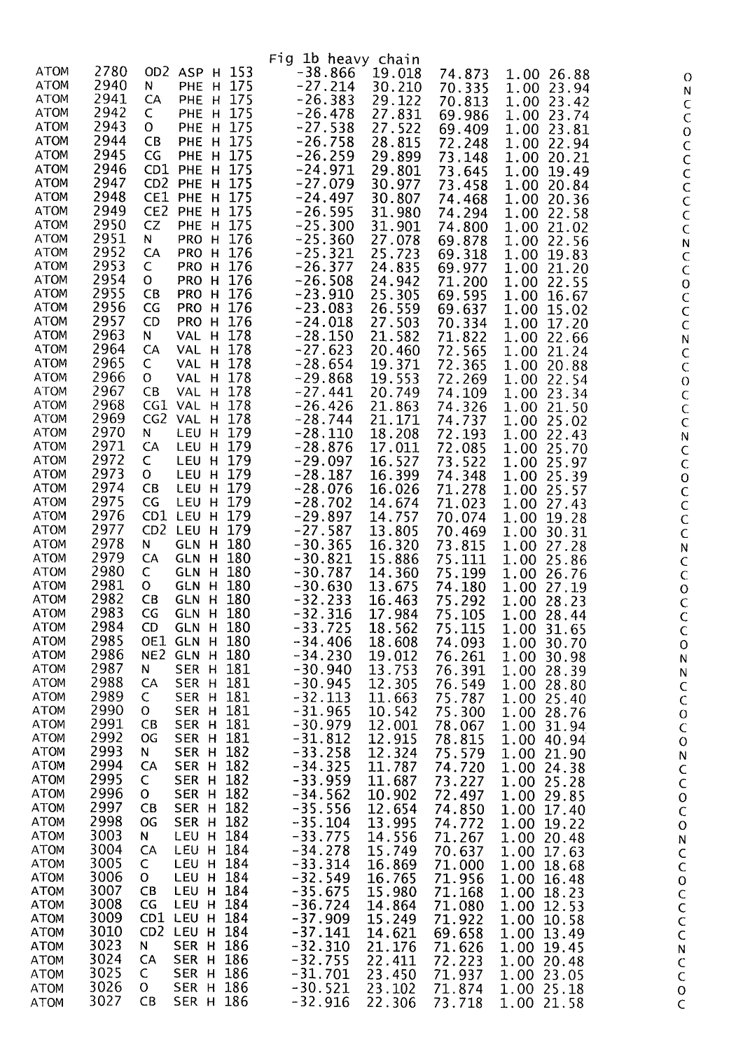

The present invention provides a model for the three-dimensional structure of a novel binding pocket based on the structure coordinates of a human IgG of κ-type, as shown in FIG. 1.

Thus, a first aspect of the present invention is an isolated compound, said compound having the structure of a human IgG binding pocket and comprising a first interacting surface, which is defined by the structure coordinates shown in FIG. 1 for an IgG κ light chain for the amino acids Q124, S127, G128, T129, S131, V133, G157, N158, S159, Q160, E161, S162, S176, S177, T178, T180, and L181, and a second interacting surface, which is defined by the structure coordinates shown in FIG. 1 for an IgG heavy chain for the amino acids P128, S129, L133, L150, K152, F175, P176, V178, L179, Q180, L184, L187 and S188, or a functional derivative of said compound. The above-defined amino acids are strictly conserved among human IgGs of κ-type. In the preferred embodiment, the present compound is limited to the part of an antibody that is responsible for the shape of the actual binding pocket and does not include the rest of a human IgG of κ type.

In one embodiment, the present invention is a binding pocket having the structure of a human IgG binding pocket and comprising a first interacting surface, which is defined by the structure coordinates shown in FIG. 1a for an IgG κ light chain for the amino acids Q124, S127, G128, T129, S131, V133, G157, N158, S159, Q160, E161, S162, S176, S177, T178, T180, and L181, and a second interacting surface, which is defined by the structure coordinates shown in FIG. 1b for an IgG heavy chain for the amino acids P128, S129, L133, L150, K152, F175, P176, V178, L179, Q180, L184, L187 and S188, or a functional derivative of said binding pocket. As mentioned above, the above-defined amino acids are strictly conserved among human IgGs of κ-type. In the preferred embodiment, the present binding pocket is an isolated binding pocket.

A specific embodiment of the present invention is a compound or binding pocket as defined above, wherein the second interacting surface is further defined by the structure coordinates shown in FIG. 1b for an IgG heavy chain for the amino acids K126, F131, D153, S181, S182, and S186. Said amino acids are highly conserved between human IgGs of κ-type. In a specific embodiment, the highly conserved are conserved to at least about 85%, in a more preferred embodiment they are conserved to at least about 90% and in the most preferred embodiment, they are conserved to at least about 95%.

In one embodiment of the present compound or binding pocket, the functional derivative thereof has a root mean square deviation from the backbone atoms of the binding pocket amino acids of not more than 2.0 Å. In a preferred embodiment, said deviation is not more than about 1.5 Å and in the most preferred embodiment, said deviation is not more than 1.0 Å. The crystal structure presented herein, which was also used in the identification of the compound or binding pocket according to the invention, can also be found using the Protein Data Bank accession code 1vge, Chacko et al., 1996. As the skilled in this field will realise, such structure coordinates usually exhibit some degree of variation due to e.g. thermal motion and slight differences in crystal packing as well as errors due to uncertainty arising from the finite resolution of the diffraction data and other errors, and compounds or binding pockets including such variations are accordingly encompassed by the present invention.

The binding pocket discussed above can also be denoted a “composite” binding pocket, since it is composed of two moieties originating from two different chains of an antibody, and more specifically from the defined, conserved amino acids of the constant 1 region of the heavy chain (CH1) of human IgG and the defined, conserved amino acids of the constant region of the κ type light chain of human IgG. Thus, in the native form of the antibody, the present binding pocket is formed between said two locations. In this context, it is to be understood that the term IgG includes herein all the human IgG sub-classes IgG1, IgG2, IgG3 and IgG4. Thus, the present invention discloses for the first time the above-defined binding pocket as isolated from its natural environment and useful as a general target for all or at least essentially all human κ-Fab constant part-comprising compositions.

An additional aspect of the present invention is a compound or a binding pocket, which corresponds to the interacting surfaces defined by the structure coordinates given herein, which are conserved among one or more of IgA, IgM, IgE and/or IgD, and which interacting surfaces define the shape of a pocket. Accordingly, such a compound or binding pocket is useful for the same applications as discussed herein, in order to define other group(s) of immunoglobulins, or subgroups thereof. Like the above-discussed IgG-binding pocket, the compound or binding pocket according to this aspect can be used to identify one or more of the other immunoglobulins and/or a composition that comprises the relevant part thereof.

One aspect of the present invention relates to an isolated and purified polypeptide consisting of a portion of a human IgG κ light chain starting at one of amino acids 93 to 110 and ending at one of amino acids 187 to 214 of human IgG κ light chain as set forth in SEQ ID NO:1. Another aspect is an isolated and purified polypeptide consisting of a portion of a human IgG heavy chain starting at one of amino acids 106 to 128 and ending at one of amino acids 215 to 225 of human IgG heavy chain as set forth in SEQ ID NO:2. The light and heavy chain sequences provided in said sequence listings are the sequences of the antibody used in the experimental part below. In the most preferred embodiment, this aspect of the invention is an isolated and purified composite polypeptide consisting of both the above described polypeptide originating from human IgG κ light chain and the polypeptide originating from human IgG κ heavy chain. In this context, it is understood that the term “polypeptide” is used for a polypeptide of sufficient length to exhibit a three dimensional structure. In one embodiment, the polypeptide originating from the light chain comprises at least about 70 amino acids, such as at least about 77 amino acids, and is up to about 125 amino acids long, such as about 121 amino acids. In one embodiment, the composite polypeptide originating from the heavy chain comprises at least about 80 amino acids, such as at least about 87 amino acids, and is up to about 120 amino acids, such as up to about 116 amino acids long. Thus, in a preferred embodiment, the present composite polypeptide comprises the binding pocket that is created between a first interacting surface, which is defined by the structure coordinates shown in FIG. 1a for an IgG κ light chain for the amino acids Q124, S127, G128, T129, S131, V133, G157, N158, S159, Q160, E161, S162, S176, S177, T178, T180, and L181, and a second interacting surface, which is defined by the structure coordinates shown in FIG. 1b for an IgG heavy chain for the amino acids P128, S129, L133, L150, K152, F175, P176, V178, L179, Q180, L184, L187 and S188. In an advantageous embodiment, the second interacting surface is further defined by the structure coordinates shown in FIG. 1b for an IgG heavy chain for the amino acids K126, F131, D153, S181, S182, and S186. As explained above, the present binding pocket is the pocket formed in a human IgG of κ-type between the defined, conserved amino acids of the constant 1 region of the heavy chain (CH1) of human IgG and the defined, conserved amino acids of the constant region of the κ type light chain (CL) of human IgG.

The procedure by which the present inventors identified the present binding pocket will be described in detail in the experimental part below. In brief, previously, in research directed to identification of highly conserved regions of antibodies, the general approach has been to align both the constant regions of the human light and heavy chains. Contrary, the present inventors focussed on alignment of the constant region of human IgG κ light chains only, which quite unexpectedly enabled the identification of a strictly conserved region located between a light and a heavy chain of a human IgG κ antibody. No such high conservation has been reported in this exact region before where the conservation has been associated to human antibodies of κ type or fragments thereof. Further, no conserved pocket shaped binding sites have been disclosed before in this region. Thus, in “Introduction to Protein Structure” (C. Brandén and J. Tooze Second edition, 1998, Garland Publishing, Inc. NY), it is mentioned that the region between the constant domains of Fab exhibit a high degree of conservation, but it is also disclosed how tightly they are packed against each other, as compared to the variable regions. Consequently, this reference in fact suggests that there is very little space, and certainly no pocket shaped space, between the Fab constant regions. In summary, the present invention was unexpected both because of the high degree of conservation of the binding site and because of the pocket shape thereof.

It will be readily apparent to those of skill in the art that the numbering of amino acids in other disclosures of human IgGs of κ type may be different than that presented herein. However, corresponding amino acids in such sequences are easily identified by visual inspection or by using commercially available homology software.

The polypeptide that consists of the binding pocket according to the invention is preferably prepared by isolation from a native source, i.e. from a human IgG of κ type. Such isolation and purification is easily performed by the skilled person following standard procedures e.g. from a cell line or a plasma sample. In brief, the entire domain, which constitutes the constant half of the Fab fragment, is isolated in a first step. For example, it is well known in the field to obtain the whole Fab fragment from the intact IgG by use of papain, and to separate the two domains of Fab one could for example use the appropriate protease or proteases. Further steps of isolating a composite polypeptide according to the invention from the Fab fragment can be performed using methods well known in this field. For example, methods analogue to those used to isolate CH1 and CL can be used (see e.g. “New recombinant bi- and trispecific antibody derivatives”, Mertens, Nico; Schoonjans, Reinilde; Willems, An; Schoonooghe, Steve; Leoen, Jannick; Grooten, Johan., Molecular Immunology Unit, Department of Molecular Biology, Flanders Interuniversity Institute of Biotechnology (VIB), Ghent University, Ghent, Belg., Focus on Biotechnology (2001), 1 (Novel Frontiers in the Production of Compounds for Biomedical Use), 195-208; and “A new model for intermediate molecular weight recombinant bispecific and trispecific antibodies by efficient heterodimerization of single chain variable domains through fusion to a Fab-chain”, Schoonjans, Reinhilde; Willems, An; Schoonooghe, Steve; Leoen, Jannick; Grooten, Johan; Mertens, Nico., Department of Molecular Biology, Molecular Immunology Unit, Flanders Interuniversity, Institute for Biotechnology (VIB), University of Ghent, Ghent, Belg. Biomolecular Engineering (2001), 17(6), 93-202).

Alternatively, the present polypeptide can be prepared by recombinant DNA techniques by appropriate manipulation of a host cell to provide expression of the above defined portion of a human IgG of κ-type. The manipulation can e.g. include steps to provide only a partial expression of such an IgG, or alternatively to include suitable cleaving sites for a subsequent cleaving of a ready expressed IgG or Fab fragment to isolate the desired part. Purification of the present polypeptides can for example be performed using conventional chromatography on a suitable matrix. Such techniques are also easily performed by the skilled person in this field.

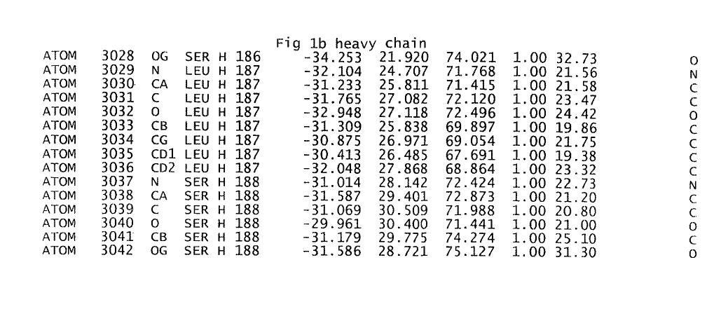

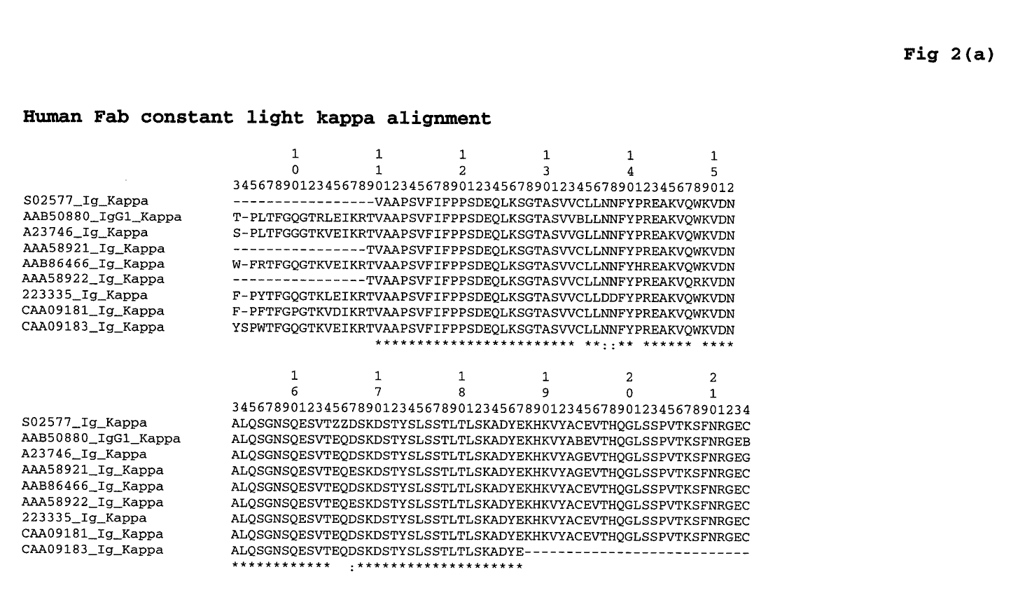

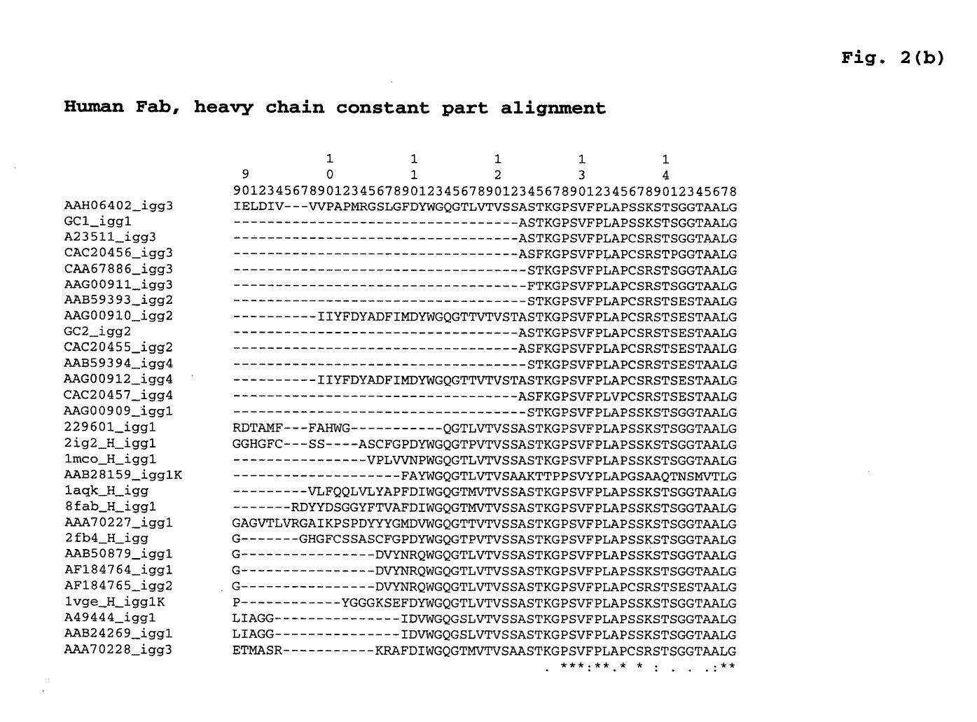

As the skilled person will realise, a polypeptide according to the invention may well include one or more mutated amino acids, as long as the mutation does not impair the polypeptide's capability to fold into a pocket shaped compound. In addition, a polypeptide according to the invention does not necessarily comprise the amino acids defined in FIGS. 2a and 2b as not highly conserved, or not conserved at al. Accordingly, in one embodiment, the present polypeptide comprises at least about 90% of CL and about 90% of CH1, such as about 95% of CL and about 95% of CH1 or preferably at least about 98% of CL and about 98% of CH1.

In a specific embodiment, the two entities that originate from the light and heavy chain, respectively, can be combined into one entity in any suitable way, e.g. by mutation of amino acid residues at specific locations in order to provide further disulphide bridge(s) between the fragments, and it is understood that any such modifications are also encompassed within the scope of the present invention

In one embodiment, the above-described binding pocket of the polypeptide according to the invention has been complexed to an organic molecule, in which complex the binding constant is at least 10⁻⁴, preferably at least 10⁻⁶ and most preferably at least 10⁻⁸ M. Thus, illustrative intervals are e.g. 10⁻⁴ to 10⁻⁸ M, such as 10⁻⁴ to 10⁻⁶ or 10⁻⁶ to 10⁻⁸. Methods of identifying chemical entities that are capable of complexing with the present binding pocket will be discussed in more detail below in relation to the second aspect of the invention. In this context, it is to be understood that the present use of the term “complex” is not intended to encompass a native human IgG of κ-type. In other words, the term “organic molecule” should not be interpreted as the remaining parts of such an IgG. As the skilled person will realise, the structure coordinates defined above for the binding pocket refer to the state before any complexing has occurred. Likewise, it is also realised that depending on the nature of the organic molecule, said structure coordinates might be slightly different in the actual complex. Sometimes an induced fit may occur.

In a specific embodiment, the complex is comprised of the above-described polypeptide and a detectable label coupled to the binding pocket. In an alternative embodiment, the label is not coupled to the interacting surfaces of the binding pocket, but so as to leave them free for subsequent interaction. More specifically, a polypeptide comprising the binding pocket can be labelled with any suitable detectable label as conventionally used in immunoassays, such as a fluorescent label, a luminescent label, a chemiluminescent label, an enzyme label, a radioactive label, an absorbance label etc. Such labelled complexes are useful e.g. in various assays for detection of human κ-Fab constant part-comprising composition thereof, as will be discussed in more detail below. The labelling of organic compounds or binding pockets with detectable labels is easily performed by the skilled person on this field using well known methods and reagents.

A second aspect of the present invention is a method of identification of a ligand for selective binding of a human κ-Fab constant part-comprising composition, wherein a polypeptide that comprises a binding pocket as defined above is used. Accordingly, the novel binding pocket according to the invention will provide a valuable target in research aimed at ligand design and/or identification. In one embodiment, the human κ-Fab constant part-comprising composition is a human IgG or a fragment thereof.

Thus, one embodiment of the present method is a method for evaluating the potential or ability of a chemical entity to associate with a human κ-Fab constant part-comprising composition, which method comprises to provide a library of chemical entities and screening of said library for ability to bind to a binding pocket of a polypeptide according to the invention. In an advantageous embodiment, the method also includes a further step of testing a selection of the chemical entities that associate with the binding pocket by contacting them with a human κ-Fab constant part-comprising composition and grading said entities according to affinity. The library preferably comprises a large number of chemical entities and is screened for chemical entities, i.e. ligands that bind to the binding pocket. The library used may be comprised of random chemical entities or, in an alternative embodiment, the library is a combinatorial library. The chemical entities may be naturally occurring or synthetic proteins, peptides, lipids, carbohydrates and any chimeric combinations thereon or any other organic or inorganic entities. In the most advantageous embodiment, the chemical entities of the library are relatively small organic molecules. In this context, “small” refers to molecules of a molecular weight below e.g. 1000 Da, preferably below about 500 Da.

In another embodiment, the present method is a structure-based or rational design of ligands capable of binding to the present binding pocket. The method utilises the structure coordinates, or structure coordinates defining a selected region, as templates for the synthesis of ligands with strong and specific binding properties. Structure-based design is a well-known technology and the skilled person can readily perform this embodiment.

Thus, the present invention can also be a virtual method, in all or in parts. Accordingly, in one embodiment, the invention is a method for evaluating the potential or ability of a chemical entity to associate with a human κ-Fab constant part-comprising composition, which method comprises a first step wherein computational means are employed to perform a fitting operation between the chemical entity and a binding pocket according to the invention and a second step wherein the results of said fitting operation are analysed to quantify the association between the chemical entity and the binding pocket.

In a more specific embodiment, the method is a method of identifying a potential ligand to a human κ-Fab constant part-comprising composition, which method comprises
(a) generating a three-dimensional structure of a binding pocket as defined above;
(b) employing said three-dimensional structure to design a candidate ligand;
(c) providing said candidate ligand;
(d) contacting the candidate ligand with a human κ-Fab constant part-comprising composition comprising said binding pocket to verify any binding; and, optionally,
(e) repeating steps (b)-(d).

In one embodiment, the human κ-Fab constant part-comprising composition is a human IgG or a fragment thereof.

In one embodiment, step (c) involves to provide a virtual structure of the designed ligand, which is virtually contacted in step (d) with a virtual structure of the binding pocket. In an alternative embodiment, step (c) involves to provide the candidate ligand experimentally, in which embodiment the contact of step (d) is also performed experimentally.

There are many commercial tools available for virtual methods of this kind. Examples of commercially available specialised computer programs that are useful in the process of selecting fragments or chemical entities are e.g. GRID (available from Oxford University, Oxford, UK); MCSS (available from Accelrys formerly MSI, San Diego); AUTODOCK (available from Scripps Research Institute, La Jolla); UNITY and FLEXX (available from Tripos Associates, St. Louis, Mo.) and DOCK (available from University of California, San Francisco).

Examples of software useful in connecting chemical entities or fragments include CAVEAT (available from University of California, Berkley), HOOK (available from Accelrys formerly MSI, San Diego); and 3D Database systems such as ISIS (MDL Information Systems, San Leandro).

Finally, programs for de novo ligand design methods include e.g. LUDI (available from Accelrys formerly MSI San Diego); LeapFrog (available from Tripos Associates, St. Louis, Mo.) and SPROUT (available from the University of Leeds, UK).

Once a chemical entity has been designed or selected the efficiency with which it binds to the binding pocket may be tested and optimised by computational evaluation. For example, a relatively small difference in energy between its free and bound states, i.e. small deformation energy of binding, is desired. Alternatively, ligands are prepared and tested in standard experiments in the lab.

In a specific embodiment, the method is a method for evaluating the potential or ability of a chemical entity to associate with a human κ-Fab constant part-comprising composition, which method comprises the steps of
(a) providing a virtual library of chemical entities;
(b) docking the chemical entities to a binding pocket as defined above;
(c) defining at least one query based on the results of the docking operation;
(d) screening all entities docked in step (b) while in the docked conformation with the query defined in step (c) for evaluating the potential or ability thereof to bind to the binding pocket;
(e) inspection and, optionally, removal of redundancy; and
(f) providing one or more of the chemical entities that bound the compound or binding pocket and experimentally testing their binding to a human κ-Fab constant part-comprising composition; and, if more than one chemical entity was tested,
(g) rating the affinities thereof to human κ-Fab constant part-comprising composition. In one embodiment, the human κ-Fab constant part-comprising composition is a human IgG or a fragment thereof.

For practical reasons, the virtual library used in the docking should comprise a limited number of chemical entities and it is preferable to reduce redundancy among said entities. Accordingly, in one embodiment, the starting material is library that comprises an already diverse selection of entities suitable for use in the docking.

In an alternative embodiment, a virtual library is provided in step (a) that consists of one conformation of the 3D structure of chemical entities, which are either commercially available or are synthesised according to known methods. An example of such a library can be prepared by exporting a file containing information of the 2D structure of the chemical entities, which are normally provided by vendors of chemical entities. The 2D structures can then be used to produce one 3D conformation by using standard molecular modelling programs that are commercially available. One example of such a program is CONCORD available from Tripos Associates, St. Louis, Mo. Further, step (a) of this embodiment comprises a further step of filtering and removal of redundancy among the entities of the library provided. The removal may be a filtering that excludes entities in accordance with certain predetermined criteria. Examples of useful filtration criteria are molecular weight and the calculated water/octanol partition coefficient. In the present method, where the goal of the screening is to obtain a putative ligand to a rather small pocket which first will be tested in solution for binding to the target protein, a suitable range of molecular weight is 200-500 Da while the calculated water/octanol coefficient can be set to be lower than 4.0. Depending on the intended use of the ligand, additional or other criteria can be set.

Further, step (b) analyses the fit of each one of the chemical entities to the binding pocket according to the invention. “Docking” means in this context the use of computational tools and available structural data to obtain new information about binding modes and molecular interactions. Thus, docking is the placement of a putative ligand in an appropriate configuration for interacting with a binding site. The database used for docking should contain a large number of diverse chemical entities, and it can be prepared for the purpose or be obtained from commercial sources. Programs for faster however more information-requiring forms of docking are also commercially available, either for searching with fixed or flexible rotational bonds, such as the UNITY 3D search algorithm, or the UNITY flexible 3D search algorithm available from Tripos Associates, St. Louis Mo. In general, docking can be accomplished by geometric matching of a ligand and its binding site, or by minimising the energy of interaction. As the skilled person in this field will know, geometric matching is faster, and searching with fixed rotational bonds is faster than with flexible ones. In the same way, docking may include flexibility of the side-chains or it may keep them fixed. In an advantageous embodiment, the results of the docking operation of step (b) are evaluated by visual inspection of the extent of contact between the interacting surface of the compound or binding pocket and the putative ligand. Additionally, or alternatively, the gaps formed between the two are calculated with the help of at least one query defined in step (c) and applied in step (d). Thus, step (d) is a query match screening wherein the coordinates of the screened entities are the docked conformation coordinates obtained from step (b) which are kept fixed during the screening procedure. Then, the positive hits from step (d) can be visually inspected in stereo-graphics to remove molecules that do not associate with the binding pocket and/or to remove molecules that are similar to selected ones in order to further discriminate against redundancy in step (e). To still be considered as a hit, the chemical entity should be complementary to the binding pocket with respect to conformation, hydrogen bonds, charge and/or hydrophobicity. Most preferably, all this aspects are satisfied.

For reasons of simplicity, in the most advantageous embodiment, step (e) is preferably a visual inspection. However, the present invention also encompasses alternative embodiments where the inspection is performed for example by computational means.

In step (f), one or more of the chemical entities that associated with the binding pocket during the screening according to step (d) are selected as candidates for further testing, which preferably means that they are provided experimentally. Many chemical entities that are present in commercial databases are also commercially available and hence easily purchased. Alternatively, the candidates are easily synthesised in accordance with standard methods. In one embodiment, the binding experiments are simply to contact the candidate(s) with a human κ-Fab constant part-comprising composition in solution by means of for instance NMR and/or Surface Plasmon Resonance techniques to evaluate any complexing. As the skilled person in this field will appreciate, in order to analyse the exact location where the candidate interacts with the compound or binding pocket, more complex methods will be required, such as crystal structure determination of complexes or alternative NMR techniques. Accordingly, a specific embodiment of the present method is a method for evaluating the potential or ability of a chemical entity to associate with a human IgG, a Fab fragment or a F(ab′)₂ fragment of κ-type by binding to the compound or binding pocket according to the invention. Methods for testing binding of a ligand to a binding site are well known in this field and hence easily performed by the skilled person in this field in accordance with routine experiments.

A third aspect of the invention is the use of a binding pocket according to the invention for identification or design of a chemical entity capable of selective binding of a human κ-Fab constant part-comprising composition. In one embodiment, the human κ-Fab constant part-comprising composition is a human IgG or a fragment thereof. Some embodiments of this aspect have been described in detail above. Thus, the products resulting from the above-described methods, i.e. the selectively binding chemical entities, are useful e.g. as ligands in chromatography methods.

Another aspect is the use of a binding pocket as defined above for site-specific modification of a human κ-Fab constant part-comprising composition. In one embodiment, the human κ-Fab constant part-comprising composition is a human IgG or a fragment thereof. More specifically, a human κ-Fab constant part-comprising composition can be modified by binding a suitable chemical entity selectively to the polypeptide that comprises a binding pocket identified by the present inventors. In an advantageous embodiment, said modification is a stabilisation of Fab-folding by binding a ligand to the compound or binding pocket.

The polypeptide that comprises the binding pocket defined above is also useful in assays wherein human κ-Fab constant part-comprising composition are detected, in which case it is preferably labelled with a suitable detectable label as discussed above. Such assays may be in solution or on solid phase. In one embodiment, the human κ-Fab constant part-comprising composition is a human IgG or a fragment thereof. In the preferred embodiment, the present assay is a competitive assay, wherein the ability of a candidate ligand to displace a known ligand's binding to a polypeptide comprising a binding pocket as defined above is evaluated.

In another embodiment, the polypeptide comprising the binding pocket defined above is used in an immunological assay for detection of a human κ-Fab constant part-comprising composition.

The polypeptide comprising a binding pocket may be used to bind cytotoxic molecules and compositions, such as radionuclides, toxins and chemotherapeutic agents that are released when the antibody associates with a cell that threatens the health of the host. More specifically, the target for the antibody can be an antigen located in for instance a cancer cell.

In addition, the present polypeptide comprising a binding pocket is also useful in various medical applications. Binding pockets, also referred to as binding sites in the present invention, are of significant utility in fields such as drug discovery. The association of natural ligands with the binding pocket of an antibody may prove to be the basis of biological mechanisms of action.

The present invention also encompasses a computer for producing a three-dimensional representation of a binding pocket according to the invention, which computer comprises
(i) a computer-readable data storage medium comprising a data storage material encoded with computer-readable data, wherein said data comprises the structure coordinates as shown in FIG. 1a for an IgG κ light chain for the amino acids Q124, S127, G128, T129, S131, V133, G157, N158, S159, Q160, E161, S162, S176, S177, T178, T180, and L181 and the structure coordinates as shown in FIG. 1b for an IgG heavy chain for the amino acids P128, S129, L133, L150, K152, F175, P176, V178, L179, Q180, L184, L187 and S188;
(ii) a working memory for storing instructions for processing said computer-readable data;
(iii) a central-processing unit coupled to said working memory and to said computer-readable data storage medium for processing said computer-machine readable data into said three-dimensional representation; and
(iv) a display coupled to said central-processing unit for displaying said three-dimensional representation.

In a specific embodiment, the computer-readable data further comprises the structure coordinates as shown in FIG. 1b for an IgG heavy chain for amino acids K126, F131, D153, S181, S182, and S186.

Thus, the computer is producing a three-dimensional graphical structure of a binding pocket as defined above. Such a graphical structure is for example useful in the methods described above, wherein selectively binding entities are designed and/or identified.

The computer according to the invention comprises standard components, for example as discussed in more detail in U.S. Pat. No. 6,183,121.

Another aspect of the invention is a machine-readable datastorage medium comprising a data storage material encoded with machine readable data, wherein said data is defined by all or a portion of the structure coordinates of a binding pocket according to the invention. Such a datastorage medium is for example useful in the methods described above.

### DETAILED DESCRIPTION OF THE DRAWINGS

FIGS. 1 (a) and (b) show the structure coordinates of the light chain and the heavy chain of, respectively, of a human IgG of κ-type. The structure coordinates given are for the amino acids identified as strictly conserved and highly conserved by the present inventors, and they are provided with the numbering conventionally used for the full sequence. The full amino acid sequence together with structure coordinate data for all amino acids can be found at for instance see RCSB Protein Data Bank website. The following abbreviations are used in FIG. 1:

“Atom type” refers to the element whose coordinates are measured. The first letter in the column defines the element.

“X, Y, Z” crystallographically define the atomic position of the element measured.

“B” is a thermal factor that measures movement of the atom around its atomic centre.

“Occ” is an occupancy factor that refers to the fraction of the molecules in which each atom occupies the position specified by the coordinates. A value of “1” indicates that each atom has the same conformation, i.e., the same position, in all molecules of the crystal.

FIGS. 2 (a) and (b) show the alignment of human IgG Fab constant part light and heavy chain sequences of κ-type used in the identification of the binding pocket according to the invention.

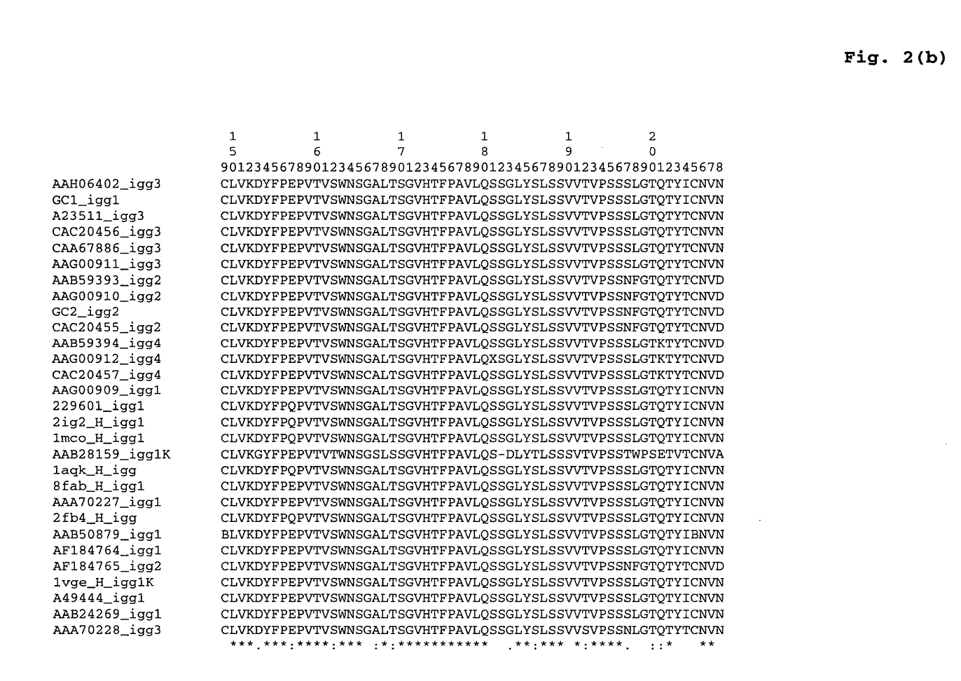

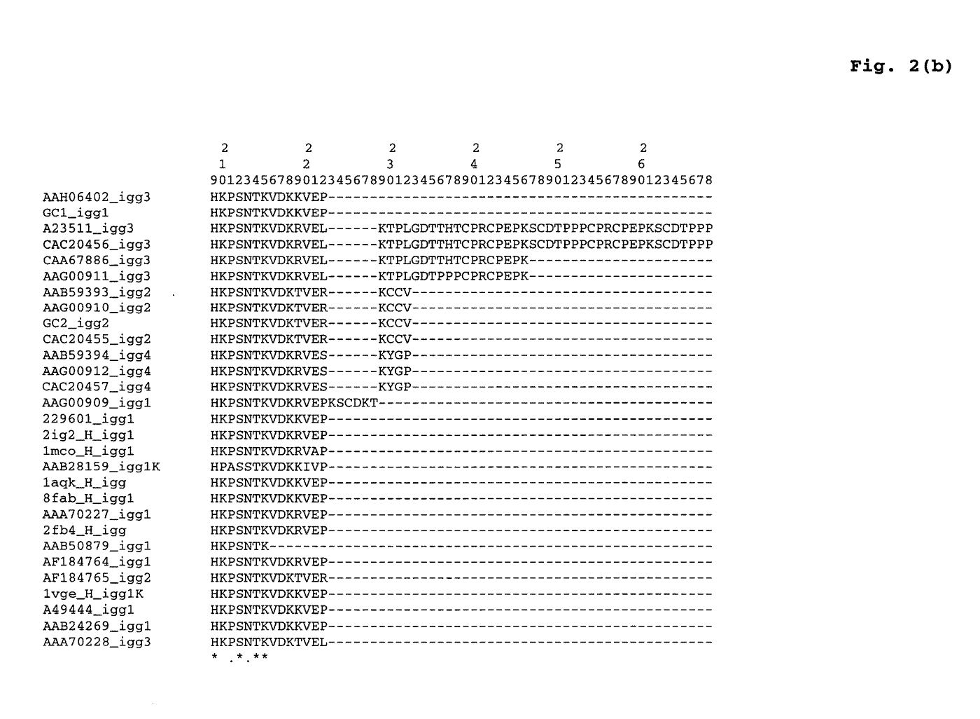

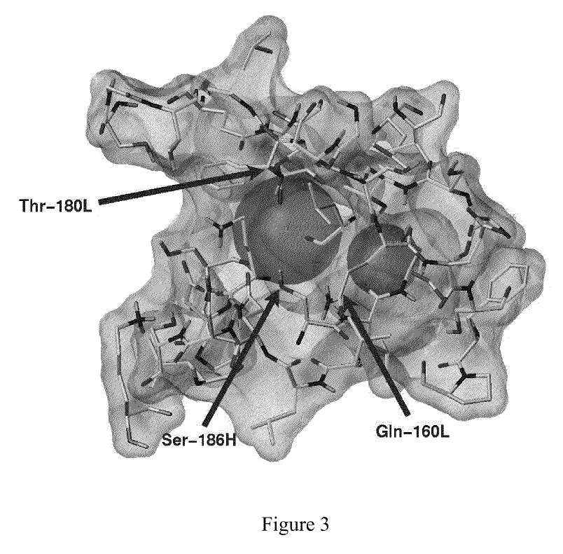

FIG. 3 shows an example of a query useful in 3D-verify mode in a docking step as used in example 2 below, wherein the residues belonging to the compound or binding pocket are shown in ball and stick. According to this query, to be considered a hit, a docked molecule should have five- or six-membered rings with centra located within each of the spheres. There are several hydrogen bond donors at the entrance of the cavity, for instance atoms from the side chains of Thr-180 and Gln-160 from the light chain and Ser-186 from the heavy chain. Possible hits might thus probably contribute with acceptors. In addition, the ligand should fit into the yellow surface of the binding site. A similar query (Query 2) was also defined by dropping the requirement of ring with centre inside the largest sphere located at the entrance of the pocket.

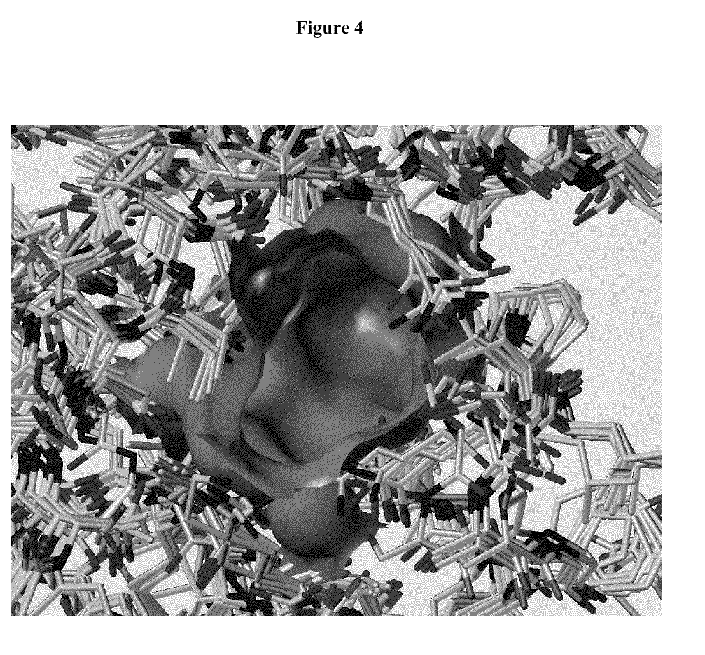

FIG. 4 shows a stick model of eight overlaid structures of Fab fragments of kappa type from the protein data bank in the region of the pocket identified according to the present invention. The superposition was carried out using a homology based method within the program BIOPOLYMER (Tripos Inc). The pdb codes of the structures used are 1ad0 and 1ad9, Banfield et al PROTEINS: Structure, Function, and Genetics. 1997. 29:161-171. 1dfb, Xiao Min He et al, Proc. Natl. Acad. Sci. USA. 1992. 89:7154-7158, 1gcl, Kwong et al Nature. 1998. 393:648-659. 1bey. Cheetham et al J. Mol. Biol. 1998. 284:85-99. 1fvd, Eigenbrot et al J. Mol. Biol. 1993. 229: 969-995. 1vge, Chacko et al J. Biol. Chem. 1996. 271: 12191-1298. 1b2w, Fan et al J. Mol. Recognit. 1999. 12:19-32. The program MOLCAD (Tripos Inc) was used to create a the surface of the pocket, which is shown as Conolly surface. The atoms of the overlaid structures surround the pocket tightly without intercepting its internal volume, implying that the pocket is present in all the structures.

### EXAMPLES

The present examples are provided for illustrative purposes only and are not to be construed as limiting the present invention as defined by the appended claims. All references given below and elsewhere in the present specification are hereby incorporated by reference.

### Example 1

### Identification of the Binding Pocket According to the Invention

To identify conserved sequence patches in the constant regions of heavy and light chain sequences of human Fab-fragments of κ-type sequence homology searches using BLAST (Altschul, 1990) followed by sequence alignments using CLUSTAL W (Thompson, 1994) were performed. A total of 29 heavy chain and nine κ light chain sequences of human IgG's were identified after the BLAST search. (FIG. 2).

The highest-resolution (2.0 Å) crystal structure of κ-Fab was investigated (accession code to the Protein Data Bank 1vge, Chacko et al., 1996). The MOLCAD (program available from Tripos Associates, St. Louis, Mo.) multi channel surface tool was used to identify possible binding sites in the constant part.

Two clefts and one pocket were identified. The pocket (FIG. 3) is located between the constant parts of the light and the heavy chain. Strictly conserved or highly conserved residues surround this pocket. Because of this conservation and since a small molecule might have higher affinity towards an invagination than a more open binding site this pocket was chosen as target. The residues forming the pocket together with some residues located at the entrance and contributing significantly to the topology of the putative binding site were identified. From the light chain these are Q124, S127, G128, T129, S131, V133, G157, N158, S159, Q160, E161, S162, S176, S177, T178, T180, L181 and they are all strictly conserved for all sequences of κ-type aligned. The residues from the heavy chain are (bold strictly- and remaining highly conserved) K126, P128, S129, F131, L133, L150, K152, D153, F175, P176, V178, L179, Q180, S181, S182, L184, S186, L187 and S188.

### Example 2

### Use of a Fab Fragment Comprising a Binding Pocket to Identify Selectively Compounds

In the example below, the term “compound” is sometimes used to denote chemical entities tested for their ability to bind selectively to a binding pocket according to the invention. However, as appears clearly from the context, such “compounds” are not the claimed compounds discussed in the section “Detailed description of the invention” and in the appended claims.

The program package SYBYL version 6.7 (available from Tripos Associates, St. Louis, Mo.) running on an OCTANE 2-CPU 195 MHz Silicon Graphics workstation was used for all modelling. This interface provides the necessary information regarding the software and databases below.

### Virtual Library

The program SELECTOR was used for filtering the molecules in MDL™ (MDL Information Systems Inc.) Available Chemical directory (ACD) allowing only for entities with a molecular weight in the range 200-500 Da and a calculated water/octanol partition coefficient (ClogP) less than 4.0. The limit 500 Da was used since it was assumed that the binding site was not appropriate to accommodate larger ligands. Also smaller entities with fewer degrees of freedom are more suitable for computational methods. Entities containing tri-phosphate or tri-peptide substructures were also rejected. After filtering the number of ACD molecules was reduced to about 111.000. A distance-based algorithm as implemented in the program Diverse Solutions version 4.04 (Pearlman, et al, 1998; available from Tripos Associates, St. Louis, Mo.) was used to select one diverse subset with 50.000 molecules for the docking database. According to Potter and Matter (Potter & Matter, 1998 Pötter, T & Matter, H. (1998) Random or rational design? Evaluation of diverse compound subsets from chemical structure databases. J. Med. Chem. 41:478-488) a database may be considered to be optimally diverse if the mean Tanimoto to the nearest neighbour is 0.85 and the standard deviation is small. The docking database of 50.000 molecules had a mean Tanomoto of 0.81 and a standard deviation of 0.11. The 3D structures were generated with CONCORD version 4.04 (Pearlman, 2001 available from Tripos Associates, St. Louis, Mo.). Molecules in the docking database were also ionised to represent their protonation state at neutral pH and minimised in 500 cycles using the MMFF94 force field (Halgren, 1996; available from Tripos Associates, St. Louis, Mo.). To increase the docking performance (speed) they were divided in smaller sets of 500 each.

### Docking Using FlexX

Docking simulations were performed with FlexX. The protein structure used was the structure named above and used for the identification of the pocket.

In the protein structure, the ε carbonyl oxygen of H:Gln-180 is located 2.5 Å away from one of the δ carboxyl oxygens of H:Asp153. This was assumed to be an error due to misinterpretation of the electron density of the carboxyamide terminal group of H:Gln-180, and consequently this group was flipped around 180°. In this corrected structure, the ε nitrogen of H:Gln-180 is at favourable hydrogen bonding distance to the carboxyl oxygen of H:Asp153. Otherwise, defaults have been used when creating the rd file and no special customisations were made. The residues belonging to the active site file in the rd file are the same as those surrounding one binding pocket identified as described in example 1, and some residues located in the surroundings and contributing to the topology of the putative binding site Prior to docking, all water molecules were removed. The best ranked conformation and its FlexX score were saved for each molecule.

Defining Queries with UNITY Verify 3D Search

A quick analysis of some thousand docked molecules inspired to the definition of two queries to extract the molecules, which actually docked inside the pocket. According to one of them (Query 1, FIG. 3), a docked molecule should, to be considered as a hit have five- or six-member rings with centra located within each one of two spheres. The smallest sphere (radius 2.0 Å) is centred inside the pocket and the largest one (radius 3.0 Å) is centred at the entrance. In a second query (Query 2), the requirement of the ring at the entrance was dropped. All hits from Query 1 should also be hits from Query 2. It might be argued that Query 1 is not contributing with new hits, but for bookkeeping reasons it might be useful to know which molecules fulfill the more demanding Query 1.

Virtual Screening of the Docked Molecules with UNITY in 3D Verify Mode

This step was performed using the two related queries defined in the previous section.

Criteria for Hit Extraction after Visual Inspection

To be considered a hit, the ligand should be complementary to the binding site with respect to conformation (shape), hydrogen bonds, charge and hydrophobicity. These criteria are based on statistical analysis of high-resolution protein structures which have shown that less than 2% of the polar atoms are buried without forming a hydrogen bond (McDonald, 1994 McDonald I K, Thornton J M. (1994), J. Mol. Biol., 238, 777-793.), and the increase in entropy as hydrophobic surfaces meet and water molecules are released (Tanford, 1980 Tanford C, (1980) The Hydrophobic Effect, 2^{nd} ed. Wiley, New York,). Complementary in shape should maximise the number of possible polar and hydrophobic interactions. In addition, the ligand should be as rigid as possible and bind in a low-energy conformation to reduce the total free energy of binding.

### Virtual Screening Results

A total of 43031 entities docked to the binding site with a favourable (negative) estimated free energy of binding, of these 98 satisfied Query 1 and 151 the less demanding Query 2. The difference, 53 entities, satisfied Query 2 but not Query 1. After visual inspection, 58 from the first set and 26 from the last set were selected. These 84 were ordered from suppliers, 76 thereof were delivered and 46 thereof turned out to be soluble as required. Thus, due to the careful selection described above, the obtained entities (compounds) can be assumed with a high probability to bind to the binding pocket, and to polypeptides comprising the binding pocket, also in in vitro binding experiments. This was verified in the experiments below.

### Screening Using NMR

All NMR experiments were performed at 298 K on a Bruker Avance 500 MHz spectrometer. The 1D saturation transfer difference method (STD NMR) was used as screening assay (Mayer M. and Meyer B. 1999. Characterization of Ligand Binding by Saturation Transfer Difference NMR Spectroscopy. Angew. Chem., Int. Ed. 38: 1784-1788) using several antibody concentrations in order to differentiate between compounds with different binding strength (Peng J. W., Lepre C. A., Fejzo J., Abdul-Manan N. and Moore J. M. 2001. Nuclear Magnetic Resonance-Based Approaches for Lead Generation in Drug Discovery. Methods in Enzymology. 338: 202-230). The antibody used was a human Fab of κ-type. In all cases ligands were tested one-by-one. On-resonance irradiation was set at 0 ppm and off-resonance irradiation was set at −40 ppm. Irradiation time in each scan was 2 s and 16 K data points were collected with 1024 scans in total. Compounds for testing were dissolved in DMSO_{d6} to a concentration of 50 mM and 5 μL of the concentrated ligand solution was added to 495 μL buffer solution. The samples thus consisted of 0.5 mM ligand, 20 mM phosphate buffer, 100 mM NaCl and 5% DMSO_{d6} in D₂O at pD 7.5, uncorrected reading on pH-meter.

Compounds were initially tested for binding with 0.5 μM antibody. Interesting ligands were further tested with protein concentrations of 100 or 20 nM. A one-dimensional ¹H-spectrum was acquired first and subsequently a saturation transfer difference (STD) spectrum was acquired. Each analysis took 60 minutes on the spectrometer. A positive result was obtained if signals from the ligand were observed in the difference spectrum. The analysis was setup for automation so that several samples could be analysed over night (usually 10-15 samples/night).

### Results

### Binding Test

As many as 46 of the virtual screening hits were tested with NMR according to the procedure described above. The results from NMR screening together with additional compound data are compiled in Table 1 below. In total 24 compounds gave a positive result in the first round with the highest antibody concentration (500 nM). These 24 compounds were subjected to a second round with an antibody concentration of 100 nM. The 4 compounds showing the strongest signal in the second round were tested for binding in a third round with 20 nM antibody. Three of the compounds in the third round gave a positive result and where thus designated as the strongest binders to the antibody out of the 46 tested compounds.

TABLE 1
Results from the NMR screening
Clogp is the calculated octanol/water partition coefficient. Concentration code as
follows: conc. 1 means 500, conc 2 100 and conc 3 20 nM antibody. NMR signal
code: 0 no, 1 weak and 2 strong signal.

| ID | Chemical name | conc 1 | conc 2 | conc 3 | ctr |
|---|---|---|---|---|---|
| AB_0000510 | alpha-pyridoin | 0 | | | |
| AB_0000530 | 1-(3-chlorophenyl)-3-methyl-2- | 0 | | | |
| | pyrazolin-5-one | | | | |
| AB_0000540 | 1,3-diphenylparabanic acid | 0 | | | |
| AB_0000580 | n1-(3-chloro-4-fluorophenyl)-2- | 1 | 0 | | |
| | [(4,6-dimethylpyrimidin-2- | | | | |
| | yl)thio]acetamide | | | | |
| AB_0000600 | 3-phenyl-1,2,4-benzotriazine | 1 | 1 | | 0 |
| AB_0000610 | 2-(4-chlorophenyl)-2,3-dihydro- | 0 | | | |
| | 1h-pyrrolo[3,4-c]pyridine-1,3- | | | | |
| | dione | | | | |
| AB_0000630 | n1-(2,3,4-trifluorophenyl)-2- | 0 | | | |
| | (1,2,4-oxadiazol-3-yl)acetamide | | | | |
| AB_0000670 | methyl n-[(5-methyl-4-phenyl- | 2 | 0 | | |
| | 1,3-oxazol-2- | | | | |
| | yl)carbonyl]carbamate | | | | |
| AB_0000690 | n1-(2,4-difluorophenyl)-2-(1,2,4- | 0 | | | |
| | oxadiazol-3-yl)acetamide | | | | |
| AB_0000700 | 3,6-di-2-pyridyl-1,2,4,5-tetrazine | 0 | | | |
| AB_0000730 | 2-benzylidene-1,3-indandione | 0 | | | |
| AB_0000740 | 5-phenyl-1,2,4-oxadiazol-3-yl n- | 0 | | | |
| | (4-fluorophenyl)carbamate | | | | |
| AB_0000750 | n-(5,5-dimethyl-7-oxo-4,5,6,7- | 0 | | | |
| | tetrahydro-benzothiazol-2-yl)- | | | | |
| | nicotinamide | | | | |
| AB_0000760 | 5-(2-phenyl-1,3-thiazol-4-yl)- | 1 | 0 | | |
| | 1,3,4-oxadiazol-2-ylhydrosulfide | | | | |
| AB_0000790 | 3-[2-oxo-2-(2-pyridyl)ethyl]-1,3- | 0 | | | |
| | dihydroisobenzofuran-1-one | | | | |
| AB_0000810 | 2-phenoxy-2-phenyl-1-ethanol | 2 | 1 | | 0 |
| AB_0000860 | 1,3-diphenylimidazolidine-2,4- | 2 | 2 | 1 | 0 |
| | dione | | | | |
| AB_0000880 | 5-bromo-3-phenyl-thiazolidine- | 0 | | | |
| | 2,4-dione | | | | |
| AB_0000900 | 1-(2-naphthoyl)imidazole | 0 | | | |
| AB_0000910 | 3-bromo-4-methoxyphenylacetone | 2 | 2 | 0 | 0 |
| AB_0000930 | 3-chloro-1-phenyl-pyrrole-2,5- | 0 | | | |
| | dione | | | | |
| AB_0000990 | 3-butyl-2-hydroxy-4h-pyrido[1,2- | 0 | | | |
| | a]pyrimidin-4-one | | | | |
| AB_0001000 | 3-(benzylamino)-1,1,1-trifluoro-2- | 1 | 0 | | |
| | propanol | | | | |
| AB_0001010 | 2-[5-(2-fluorobenzoyl)-2- | 2 | 2 | 2 | 1 |
| | thienyl]acetonitrile | | | | |
| AB_0001020 | 5-(3,5-difluorobenzyl)-3-(2- | 1 | 0 | | |
| | thienyl)-1,2,4-oxadiazole | | | | |
| AB_0001030 | 2-chloro-3- | 1 | 0 | | |
| | (trifluoromethyl)benzaldehyde | | | | |
| AB_0001040 | 2-hydroxy-3-(2-methyl-1- | 1 | 1 | | 0 |
| | propenyl)-1,4-naphthoquinone | | | | |
| AB_0001060 | 2-(2-imino-thiazol-3-yl)-1- | 2 | 0 | | |
| | naphthalen-2-yl-ethanone | | | | |
| AB_0001070 | imiloxan hydrochloride | 1 | 1 | | |
| AB_0001080 | 2-(benzylthio)-5-methyl-4,5- | 0 | | | |
| | dihydro-1h-imidazol-3-ium | | | | |
| | chloride | | | | |
| AB_0001090 | n-(3-chlorophenyl)-maleimide | 1 | 0 | | |
| AB_0001100 | ethyl 4-oxo-1,4-dihydroquinoline- | 0 | | | |
| | 3-carboxylate | | | | |
| AB_0001130 | 3-amino-n-[2-(methylthio)ethyl]- | 0 | | | |
| | 4-oxo-3,4-dihydroquinazoline-2- | | | | |
| | carboxamide | | | | |
| AB_0001150 | 1-[(3,4-dichlorobenzyl)oxy]-1h- | 2 | 0 | | |
| | imidazole | | | | |
| AB_0001170 | 3-[(2,4-dichlorobenzyl)amino]- | 0 | | | |
| | 1,1,1-trifluoro-2-propanol | | | | |
| AB_0001180 | 3-oxo-2-phenyl-2,3-dihydro-4- | 0 | | | |
| | pyridazinecarboxylic acid | | | | |
| AB_0001190 | 4-[1-(2-phenylethyl)-(1h)-pyrazol- | 2 | 0 | | |
| | 4-yl]pyridine | | | | |
| AB_0001200 | methyl 1-hydroxy-2-naphthoate | 1 | 0 | | |
| AB_0001220 | 1-(3- | 2 | 0 | | |
| | trifluoromethylphenyl)imidazole | | | | |
| AB_0001230 | (2-naphthoxy)acetic acid, n- | 0 | | | |
| | hydroxysuccinimide ester | | | | |
| AB_0001240 | methyl 3-(5-chloro-2- | 1 | 1 | | 0 |
| | methoxyphenyl)-2,3- | | | | |
| | epoxypropionate | | | | |
| AB_0001250 | 1-(3,4-dichlorophenyl)-1,3,3- | 2 | 2 | 1 | 0 |
| | trimethylurea | | | | |
| AB_0001260 | 2-pyridyl 2-(2,3-dihydro-1,4- | 0 | | | |
| | benzodioxin-2-yl)-1,3-thiazole-4- | | | | |
| | carbothioate | | | | |
| AB_0001270 | 1-[(4-chlorobenzyl)amino]-3- | 1 | 0 | | |
| | (phenylthio)propan-2-ol | | | | |
| AB_0001290 | 3-[(4-chlorophenoxy)methyl]-5- | 2 | 1 | | 0 |
| | [(2-pyridylthio)methyl]-1,2,4- | | | | |
| | oxadiazole | | | | |
| AB_0001300 | 3-(2-thienylcarbonyl)-4h- | 1 | 0 | | |
| | pyrido[1,2-a]pyrimidin-4-one | | | | |

### Example 3

### Control Experiments

### Example 3a

### Use of a F(ab′)2 Fragment Comprising the Binding Pocket to Verify Binding of a Selected Compound

The present example was performed with a F(ab′)2 fragment of a different specificity, i.e. a different variable part, from the one used in Example 2 above in order to verify that binding of one the selected compounds still occurred.

The testing was performed as described above in Example 2, but this time using 1 μM protein and using compound AB_{—}0000860 as defined above in table 1. The results were positive, which implies that there is an interaction between AB_{—}0000860 and at least two kappa Fab fragments of different specificities.

### Example 3b

### Use of a Fab″ Fragment of Lambda-Type to Verify Non-Binding of the Selected Compound Did not

Again, compound AB_{—}0000860 as defined above in table 1 was used, but this time to verify that it did not bind to a Fab fragment of lambda-type, which consequently does not comprise any binding pocket according to the invention.

Apart from the different Fab fragment, the testing was performed as described above in Example 2. The results were negative, which implies that AB_{—}0000860 does not bind lambda-type Fab.

### CONCLUSION

Accordingly, since the compound which was first selected via molecular modelling due to its good fit into the binding pocket was also capable of binding to two different κ-type fragments, of different variable parts, and was also unable to bind to a λ-type Fab fragment lacking the pocket, it is concluded that said binding should take place in the binding pocket rather than to any other part of the Fab fragment.

Thus, not only was it shown above that a compound selected via molecular modelling is capable of binding to two different Fab fragments, but in addition it is not capable of binding to a Fab fragment that evidently lacks the binding pocket. Accordingly, the conclusion must be that a polypeptide that consists of the present binding pocket is capable of binding herein identified compounds, as exemplified by compound AB_{—}0000860. This should be due to its highly conserved region, as illustrated in the alignment shown in FIGS. 2a and 2b.

To further verify a candidate compound's exact binding to the present binding pocket, the skilled person can perform crystallisation experiments according to standard protocols.

The above examples illustrate specific aspects of the present invention and are not intended to limit the scope thereof in any respect and should not be so construed. Those skilled in the art having the benefit of the teachings of the present invention as set forth above, can effect numerous modifications thereto. These modifications are to be construed as being encompassed within the scope of the present invention as set forth in the appended claims.

1-13. (canceled)

14. A method for evaluating the potential or ability of a chemical entity to bind a human κ-Fab constant part-comprising composition, which method comprises a first step wherein computational means are employed to perform a fitting operation between the chemical entity and the binding pocket of a polypeptide, and a second step wherein the results of said fitting operation are analysed to quantify the binding between the chemical entity and the binding pocket;
wherein said polypeptide is a composite polypeptide consisting of one polypeptide consisting of a portion of a human IgG κ light chain starting at one of amino acids 93 to 110 and ending at one of amino acids 187 to 214 of human IgG κ light chain as set forth in SEQ ID NO:1 and one polypeptide consisting of a portion of a human IgG heavy chain starting at one of amino acids 106 to 128 and ending at one of amino acids 215 to 225 of human IgG heavy chain as set forth in SEQ ID NO:2.

15. A method of identifying a potential ligand to a human κ-Fab constant part-comprising composition, which method comprises
(a) generating a three-dimensional structure of the binding pocket of a polypeptide;
(b) employing said three-dimensional structure to design a candidate ligand;
(c) providing said candidate ligand;
(d) contacting the candidate ligand with a human κ-Fab constant part-comprising composition comprising said binding pocket to verify any binding; and, optionally,
(e) repeating steps (b)-(d);
wherein said polypeptide is a composite polypeptide consisting of one polypeptide consisting of a portion of a human IgG κ light chain starting at one of amino acids 93 to 110 and ending at one of amino acids 187 to 214 of human IgG κ light chain as set forth in SEQ ID NO:1 and one polypeptide consisting of a portion of a human IgG heavy chain starting at one of amino acids 106 to 128 and ending at one of amino acids 215 to 225 of human IgG heavy chain as set forth in SEQ ID NO:2.

16. A method for evaluating the potential or ability of a chemical entity to associate with a human κ-Fab constant part-comprising composition, which method comprises the steps of
(a) providing a virtual library of chemical entities;
(b) docking the chemical entities to the binding pocket of a polypeptide;
(c) defining at least one query based on the results of the docking operation;
(d) screening all entities docked in step (b) while in the docked conformation with the query defined in step (c) for evaluating the potential or ability thereof to bind to the compound or binding pocket;
(e) inspection and, optionally, removal of redundancy; and
(f) providing one or more of the chemical entities that bound the binding pocket and experimentally testing their binding to a human κ-Fab constant part-comprising composition; and, if more than one chemical entity was tested,
(g) rating the affinities thereof to human κ-Fab constant part-comprising composition;
wherein said polypeptide is a composite polypeptide consisting of one polypeptide consisting of a portion of a human IgG κ light chain starting at one of amino acids 93 to 110 and ending at one of amino acids 187 to 214 of human IgG κ light chain as set forth in SEQ ID NO:1 and one polypeptide consisting of a portion of a human IgG heavy chain starting at one of amino acids 106 to 128 and ending at one of amino acids 215 to 225 of human IgG heavy chain as set forth in SEQ ID NO:2.

17. The method of claim 16, wherein step (a) further comprises a subsequent step of filtering and removal of redundancy among the entities of the library provided.

18. The method of claim 17, wherein the results of the docking operation of step (b) are evaluated by visual inspection of the contact between the interacting surface of the binding pocket and the molecular surface(s).

19-25. (canceled)

26. A method for evaluating the potential or ability of a chemical entity to bind a human κ-Fab constant part-comprising composition, which method comprises a first step wherein computational means are employed to perform a fitting operation between the chemical entity and the binding pocket of a polypeptide, and a second step wherein the results of said fitting operation are analysed to quantify the binding between the chemical entity and the binding pocket;
wherein said polypeptide comprises a binding pocket located between a first interacting surface, which is defined by the structure coordinates shown in FIG. 1a for an IgG κ light chain for the amino acids Q124, S127, G128, T129, S131, V133, G157, N158, S159, Q160, E161, S162, S176, S177, T178, T180, and L181, and a second interacting surface, which is defined by the structure coordinates shown in FIG. 1b for an IgG heavy chain for the amino acids P128, S129, L133, L150, K152, F175, P176, V178, L179, Q180, L184, L187 and S188.

27. A method of identifying a potential ligand to a human κ-Fab constant part-comprising composition, which method comprises
(a) generating a three-dimensional structure of the binding pocket of a polypeptide;
(b) employing said three-dimensional structure to design a candidate ligand;
(c) providing said candidate ligand;
(d) contacting the candidate ligand with a human κ-Fab constant part-comprising composition comprising said binding pocket to verify any binding; and, optionally,
(e) repeating steps (b)-(d);
wherein said polypeptide comprises a binding pocket located between a first interacting surface, which is defined by the structure coordinates shown in FIG. 1a for an IgG κ light chain for the amino acids Q124, S127, G128, T129, S131, V133, G157, N158, S159, Q160, E161, S162, S176, S177, T178, T180, and L181, and a second interacting surface, which is defined by the structure coordinates shown in FIG. 1b for an IgG heavy chain for the amino acids P128, S129, L133, L150, K152, F175, P176, V178, L179, Q180, L184, L187 and S188.

28. A method for evaluating the potential or ability of a chemical entity to associate with a human κ-Fab constant part-comprising composition, which method comprises the steps of
(a) providing a virtual library of chemical entities;
(b) docking the chemical entities to the binding pocket of a polypeptide;
(c) defining at least one query based on the results of the docking operation;
(d) screening all entities docked in step (b) while in the docked conformation with the query defined in step (c) for evaluating the potential or ability thereof to bind to the compound or binding pocket;
(e) inspection and, optionally, removal of redundancy; and
(f) providing one or more of the chemical entities that bound the binding pocket and experimentally testing their binding to a human κ-Fab constant part-comprising composition; and, if more than one chemical entity was tested,
(g) rating the affinities thereof to human κ-Fab constant part-comprising composition;
wherein said polypeptide comprises a binding pocket located between a first interacting surface, which is defined by the structure coordinates shown in FIG. 1a for an IgG κ light chain for the amino acids Q124, S127, G128, T129, S131, V133, G157, N158, S159, Q160, E161, S162, S176, S177, T178, T180, and L181, and a second interacting surface, which is defined by the structure coordinates shown in FIG. 1b for an IgG heavy chain for the amino acids P128, S129, L133, L150, K152, F175, P176, V178, L179, Q180, L184, L187 and S188.

29. The method of claim 28, wherein step (a) further comprises a subsequent step of filtering and removal of redundancy among the entities of the library provided.

30. The method of claim 29, wherein the results of the docking operation of step (b) are evaluated by visual inspection of the contact between the interacting surface of the binding pocket and the molecular surface(s).
